(19) United States
(12) Patent Application Publication
(10) Pub. No.: US 2015/0012457 A1
(43) Pub. Date: Jan. 8, 2015

(54) METHOD AND SYSTEM FOR TRACKING SHIPPED UNITS DURING MOVEMENT OF GOODS WITHIN SUPPLY CHAIN CHANNELS

(71) Applicant: HOUND DOG, LLC, Royal Oaks, CA (US)

(72) Inventors: ABEL GONZALEZ, SALINAS, CA (US); ALVARO GONZALEZ, SALINAS, CA (US); ANTONIO SABAREZ, II, MONTEREY, CA (US)

(73) Assignee: HOUND DOG LLC, ROYAL OAKS, CA (US)

(21) Appl. No.: 13/933,752

(22) Filed: Jul. 2, 2013

(51) Int. Cl. G06Q 10/08

(52) U.S. Cl. CPC G06Q 10/0833
USPC 705/333

(57) ABSTRACT

A method, system and device are provided that collect and provide information related to goods in transit, as made available for purchase and/or after purchase. The goods may be or include consumer products, commodities, equipment, food, food products, agricultural supplies and agricultural products. A label may include a bar code, a quick response code, an RFID chip and/or a radio frequency or photonic communications device.

### BACKGROUND

1. Technical Field

The present invention relates generally to tracking, documenting and reporting the positions of goods in transport and, more particularly, to various systems, methods, and electronic devices configured to provide for tracking, documenting and reporting the locations of goods in transit.

2. Description of the Related Art

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Security assurance of shipped goods is becoming of increasing importance as both a competitive advantage in the market place and as a matter of public safety. Even when the origin of an item is determined, concern may exist that the item may have been tampered with in transit. In one particular area of concern, a growing number of consumers are particularly interested in information regarding the farm-to-table origin and processing of the food that they consume and purchase. A consumer type that is generally classed as “foodies” are often willing to pay a premium for food that is provided from an original and identified source that they trust and regard with affection. Tracking the origin and pathway of food in a supply chain pathway may thus provide information that is thus valuable for both reducing the incidence of breaches in food security and for application in generating additional branding advantages to competitors in the market place.

There is therefore a long felt need to acquire and document information related to the origin and transport of products, including but limited to food and food products, that are relevant to consumer preferences and public safety concerns.

### SUMMARY AND OBJECTS OF THE INVENTION

Toward these objects and other objects that are made obvious to one of ordinary skill in the art in light of the present disclosure, a method, system and device are provided that collect and provide information related to food and/or food products.

This Summary is provided to introduce a selection of concepts in a simplified form that are further described below in the Detailed Description. Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

In a first aspect of the method of the present invention, an invented electronic device is provided that stores information related to a shipment of an item, such as, but not limited to, a manufactured product, a substance, and/or a discrete portion of food. An exemplary portion of food may be or include a selection of food separated that is for sale as an individual item or a collection of associated portions of food. More generally, the item of interest may be or comprise, a portion of food, an agricultural product, an equipment, a chemical, a liquid, a contained gas and/or other physical products or substances that are shipped for sale or delivery.

The invented electronic device (hereinafter, “the invented device”) may optionally be or comprise an electronic memory and a radio frequency communications circuit whereby information may be written into and/or read out of the memory via the radio frequency communications circuit. The radio frequency communications circuit optionally may comprise an antenna and/or a light energy detector. It is understood that various embodiment of the radio frequency communications circuit may communicate via transmission of electromagnetic energy of different frequencies and frequency bands.

In a second optional aspect of the present invention, the memory may record an identifier that is associated in a remote database with a particular food portion or other goods. The device may be enabled to transmit the identifier when interrogated by an external reader having a wireless communications transponder to a remote database via an electronic communications device, such as the Internet and/or a telephony network. The external reader and device and/or the device may be further adapted to enable the reader to generate or provide a time date stamp and a location identifier and/or geolocational data to the device for storage.

The device may be or comprise a radio frequency identification circuit that accepts energy from electromagnetic energy, wherein the electromagnetic energy may be provided by or in concert with an attempt to access information from the device and/or provide information for storage in the device. The device may optionally include an electrical energy battery and/or a capacitive element that is adapted to provide sufficient energy for operation of the device for or beyond an anticipated device life span. Alternatively or additionally, the device may comprise a solar energy converter produces electrical energy derived from received light energy. The device may further or alternatively include a time date data generator and/or a real time clock that provides time date stamps or time indications for storage within the device and/or for transmission to a remote database.

According to the method of the present invention, the device may be passage through two or a plurality of locations and readings of the presence of the device in proximity to readers may be provided to a remote database and/or stored in the device itself. The device may include information related to a food portion with which the device is associated and with which food portion the device is intended to be shipped with. The stored information, to include a food portion identifier, may be encrypted or unencrypted in whole or in part as maintained by the device. The stored information may include an identification of, and/or information related to, a location, a farm and/or a location within a farm from which the associated food portion was shipped and/or at which the food portion was stored, processed, planted, grown and/or harvested.

The device may be directly or indirectly coupled with a food portion and or a container that houses the food portion at least for shipping purposes. The device may alternatively or additionally be comprised within a label structure that is attached to, coupled with or comprised within a container of the food portion or other goods.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of embodiments of the present invention without limitation to the claimed subject matter.

### BRIEF DESCRIPTION OF THE DRAWINGS

These and other features, aspects, and advantages of the present disclosure will become better understood when the following detailed description of certain exemplary embodiments is read with reference to the accompanying drawings in which like characters represent like parts throughout the drawings, wherein:

FIG. 1 is a network block diagram presenting an electronic communications network that communicatively couples an exemplary invented tag device, an originating computer system, a tag database server, a plurality of tag readers, a tag reader server, a retail computer system, a mobile consumer communications device, a point of sale computer system, a purchaser computer system, and a retail database server;

FIG. 2A is a schematic drawing of an exemplary first tag device;

FIG. 2B is a schematic drawing of an exemplary first alternate tag device;

FIG. 3A is a perspective view of a basic label attached to a first container;

FIG. 3B is a side view of the basic label of FIG. 3A;

FIG. 3C is a perspective view of the basic label of FIG. 3A coupled with the first tag device of FIG. 2A and attached to a different container;

FIG. 3D is a side view of the basic label of FIG. 3A coupled with the first tag device of FIG. 2A;

FIG. 3E is a perspective view of the basic label of FIG. 3A coupled with the first alternate tag device of FIG. 2B and attached to another container;

FIG. 3F is a side view of the basic label of FIG. 3A coupled with the first alternate tag device of FIG. 2B;

FIG. 3G is a side view of the basic label of FIG. 3A coupled with the first alternate tag device of FIG. 2B and directly coupled with a consumer good;

FIG. 3H is a perspective view of the first alternate tag device of FIG. 2B placed among strawberries and without attachment;

FIG. 4A is a schematic diagram of the originating computer system of FIG. 1;

FIG. 4B is a schematic diagram of the tag database server of FIG. 1;

FIG. 4C is a schematic diagram of the retail computer system of FIG. 1;

FIG. 4D is a schematic diagram of mobile consumer communications device of FIG. 1;

FIG. 4E is a schematic diagram of the point of sale computer system of FIG. 1;

FIG. 4F is a schematic diagram of the second purchaser computer system of FIG. 1;

FIG. 4G is a schematic diagram of the retail database server of FIG. 1;

FIG. 4H is a schematic diagram of the tag reader server of FIG. 1;

FIG. 5 is a schematic diagram of a first exemplary tag reader of FIG. 1;

FIG. 6A is a block diagram of an exemplary first tag identifier record that associates a tag identifier with an item identifier and optionally a tag network address;

FIG. 6B is a block diagram of an exemplary first item record that associates an item identifier with a tag identifier;

FIG. 6C is a block diagram of an exemplary first history record that maintains information associated with a unique tag identifier, to include a plurality of registration records containing data received from a tag reader of FIG. 1;

FIG. 6D is an exemplary registration record as maintained within a history record of

FIG. 6C by the tag database server of FIG. 1;

FIG. 6E is an exemplary observation record as transmitted by a tag reader of FIG. 1;

FIG. 7 is a process chart of the invented method;

FIG. 8 is a flow chart of the operation of the tag database server of FIG. 1 and FIG. 4B in accordance with the invented method;

FIG. 9 is a flow chart of the operation of the first tag reader of FIG. 1 and FIG. 5 in accordance with the invented method;

FIG. 10 is a flow chart of an alternate operation of the exemplary first tag reader of FIG. 1 and FIG. 5 that is also in accordance with the invented method;

FIG. 11A is a flowchart of alternate, optional and additional aspects of the invented method as performed by a tag reader FIG. 1 and FIG. 5;

FIG. 11B is a tag address look up table of FIGS. 1, 4B, 4C, 4E, 4G, 4H and 5;

FIG. 12 is a software flowchart of a process of the mobile device of FIG. 1 and FIG. 4D in communication with a retail system of FIG. 1 and FIG. 4C, a point of sale system of FIG. 1 and FIG. 4E, and/or a retail database server of FIG. 1 and FIG. 4G;

FIG. 13 is an additional software flowchart of an alternate process of the mobile device of FIG. 1 and FIG. 4D in communication with a retail system of FIG. 1 and FIG. 4C, a point of sale system of FIG. 1 and FIG. 4E, and/or a retail database server of FIG. 1 and FIG. 4G;

FIG. 14 is a software flowchart of a process of the point of sale system of FIG. 1 and FIG. 4E;

FIG. 15 is a block diagram of a purchase message as issued by the point of sale system of FIG. 1 and FIG. 4E;

FIG. 16 is a block diagram of a customer record as maintained by the a retail database server of FIG. 1 and FIG. 4G;

FIG. 17 is a block diagram of a first query message by the first tag device of FIG. 2A;

FIG. 18 is a block diagram of a second query message by the first tag device of FIG. 2A;

FIG. 19 is a software flowchart of a process of the a system or server having access to one or more history records of FIG. 6C and responding to query messages of FIG. 4A;

FIG. 20 is a block diagram of a first reply message by the second tag server 4B; and

FIG. 21 is a block diagram of a second reply message by the second tag server 4B.

### DETAILED DESCRIPTION

The assurance of identity and security of shipped goods is of significant interest to the general public and not uncommonly to those charged with public safety. While trademarks are intended to distinguish goods of particular origin from other similar goods available in the market, addressing the risks to consumers of purchasing substandard, defective or tampered goods go beyond mere trademark compliance. The invented method is distinguished from the prior art by of shipping security and origination assurance by the several invented aspects and attendant benefits as disclosed herein.

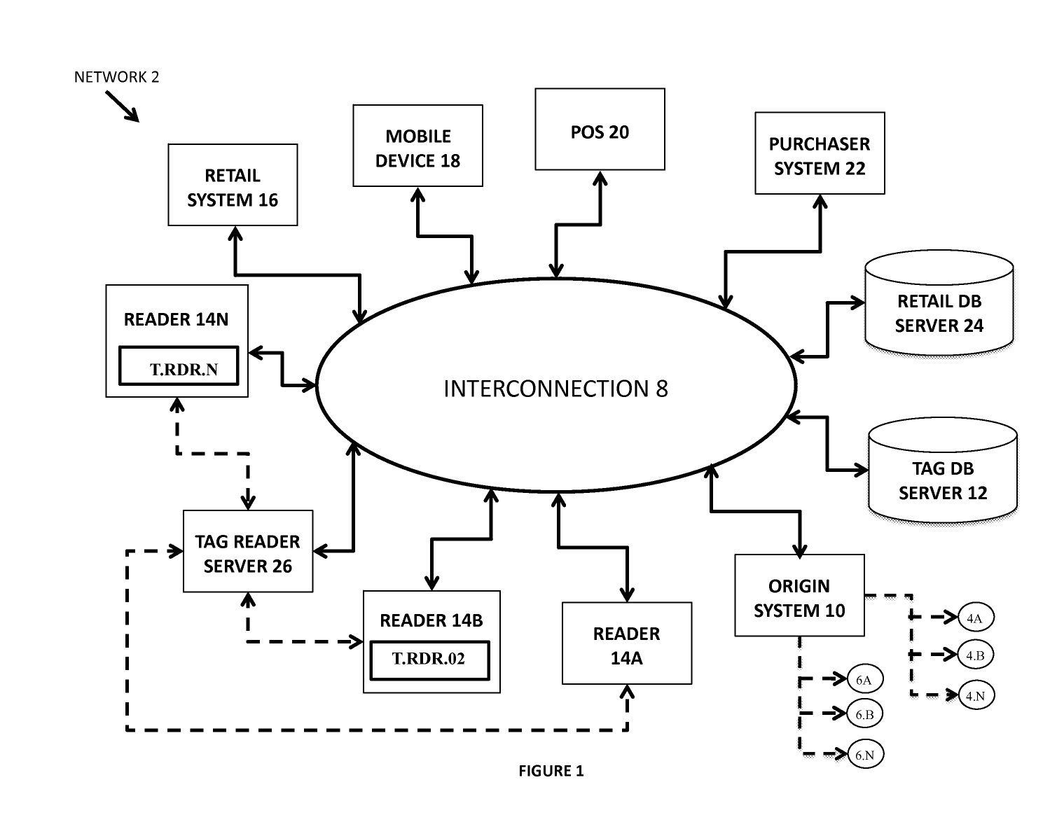

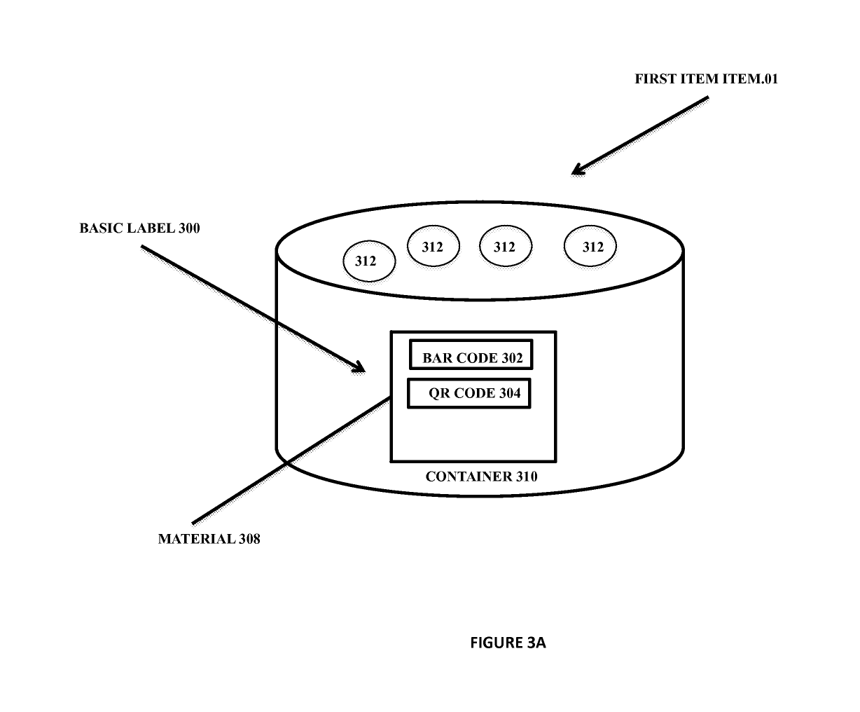

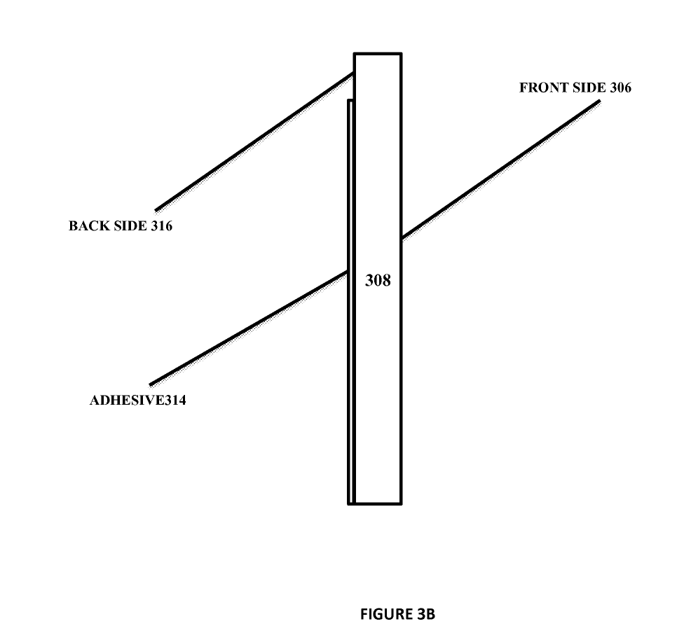

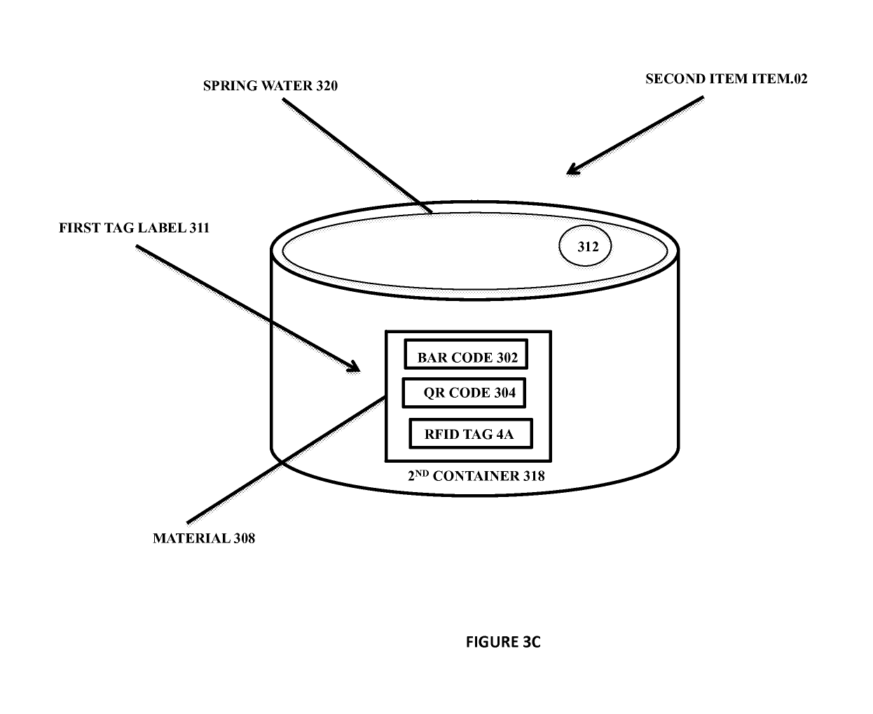

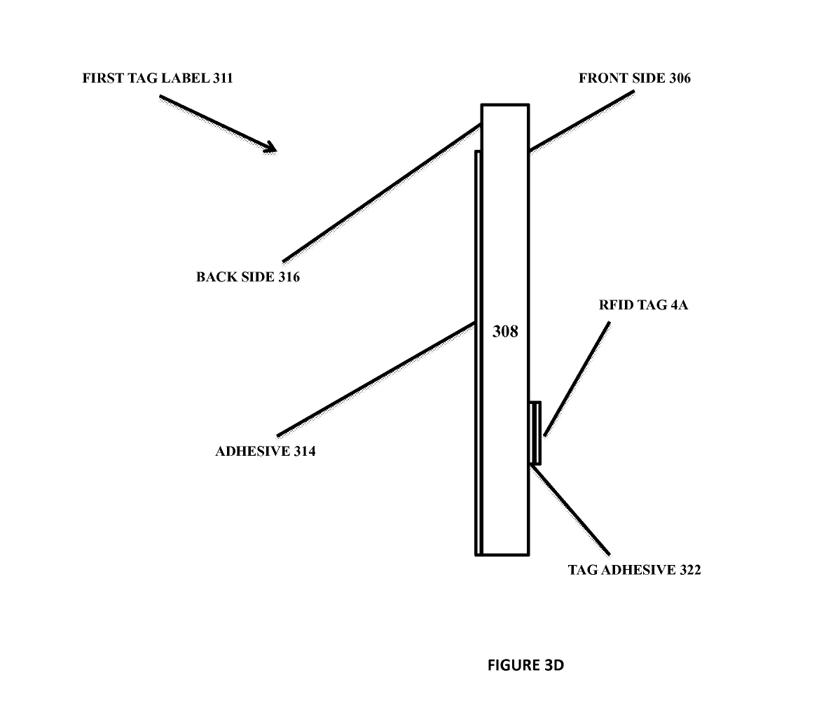

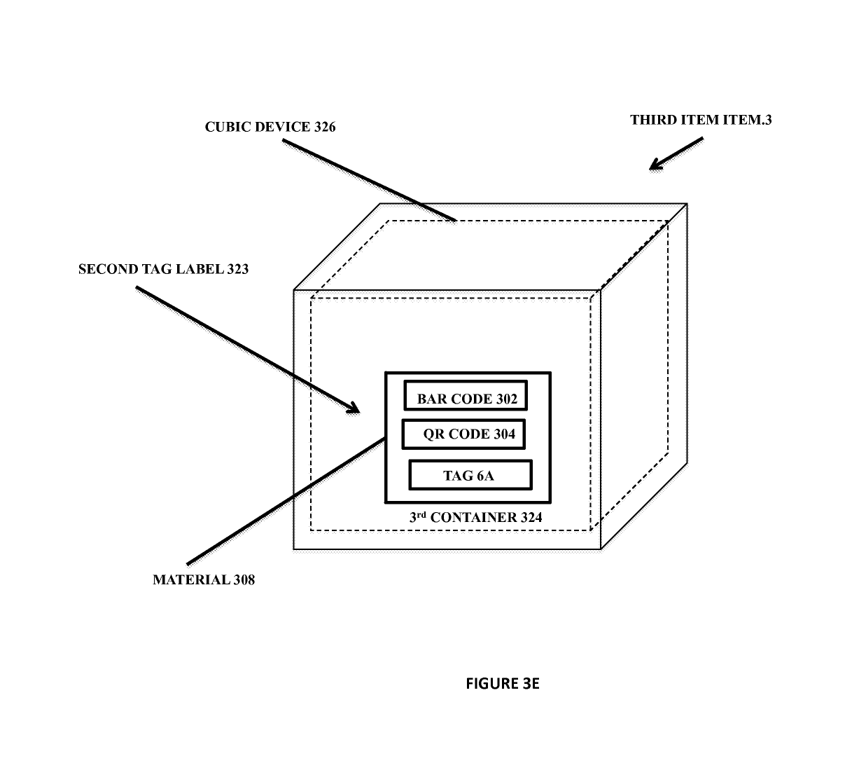

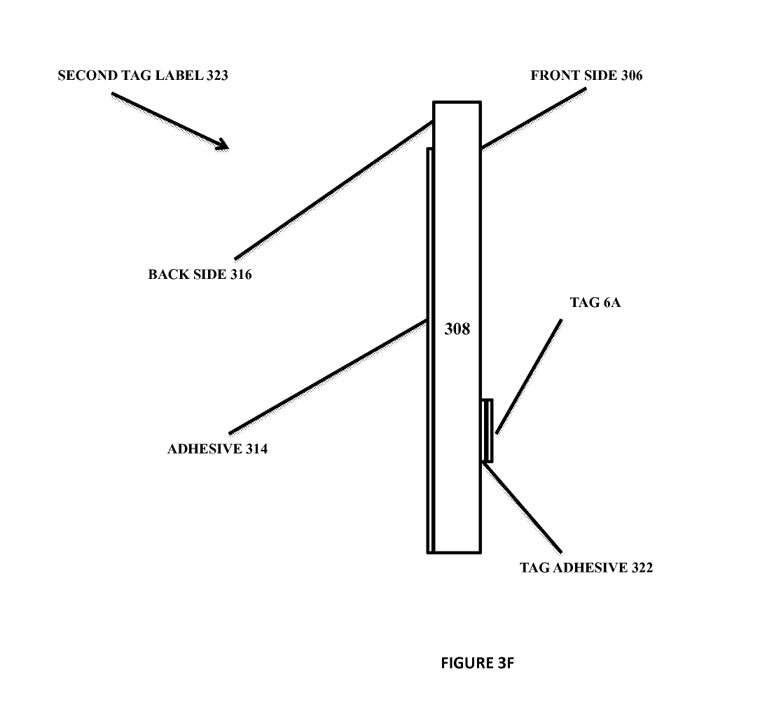

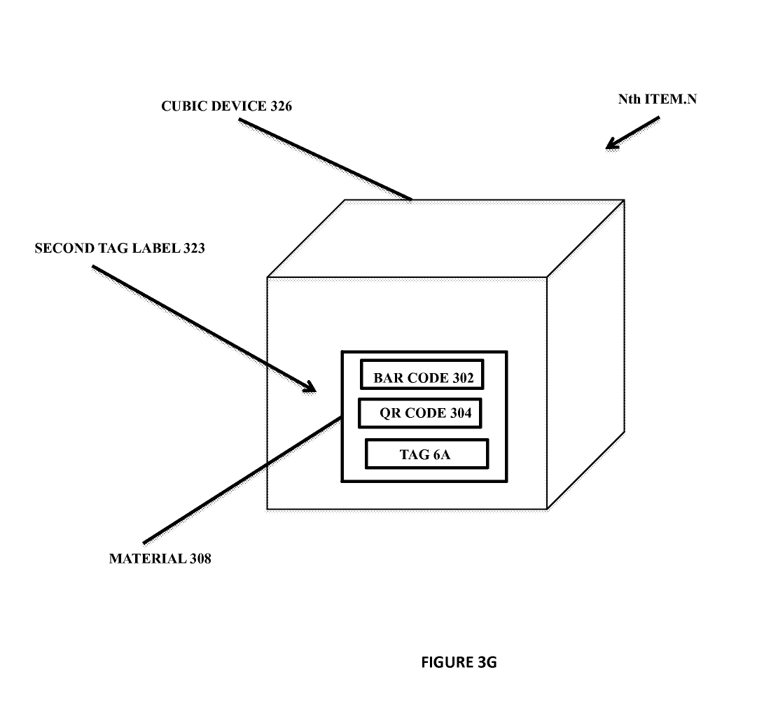

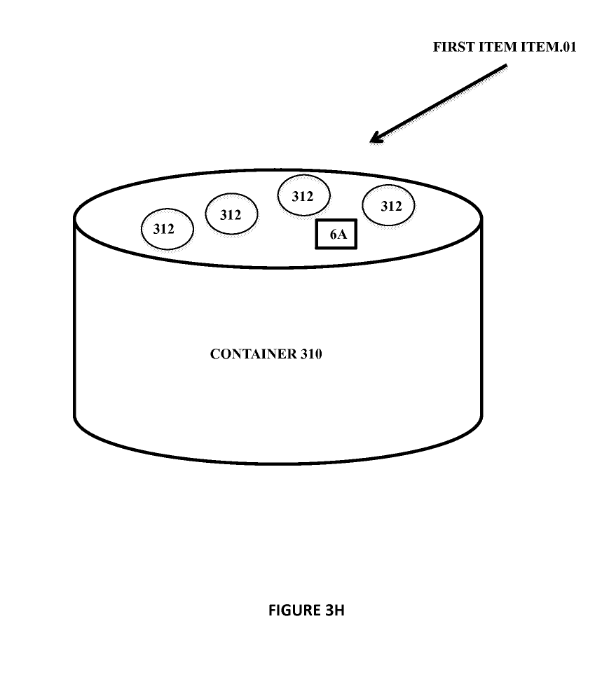

Referring now generally to the Figures and particularly to FIG. 1, FIG. 1 is a network block diagram presenting an electronics communications network 2 that enables the various aspects of the invented method and each of a plurality of invented radio frequency identification devices 4A-4N and each of a plurality of alternate invented tag devices 6A-6N. It is understood that one or more of the plurality of invented radio frequency identification devices 4A-4N and/or one or more of the plurality of alternate invented tag devices 6A-6N may be affixed to a basic label 300 as shown in FIG. 3A-3G. One or more basic labels 300 may further comprise visual or imprinted identification patterns as further disclosed herein. The plurality of radio frequency identification devices 4A-4N and the plurality of alternate invented tag devices 6A-6N are referred to herein collectively as “tag devices 4A-4N & 6A-6N”.

The electronics communications network 2 (hereinafter “network 2”) comprises an electronic interconnection communications network 8 that may be or comprise the Internet, and/or one or more telephony networks, a computer networks, landline based communications networks and/or a wireless communications network.

The electronic interconnection communications network 8 (hereinafter, “interconnection 8”) communicatively couples an originating computer system 10, a tag database server 12, a plurality of tag readers 14A-14N, a retail computer system 16, a mobile consumer communications device 18, a point of sale computer system 20, a purchaser computer system 22, a retail database server 24 and an optional reader server 26.

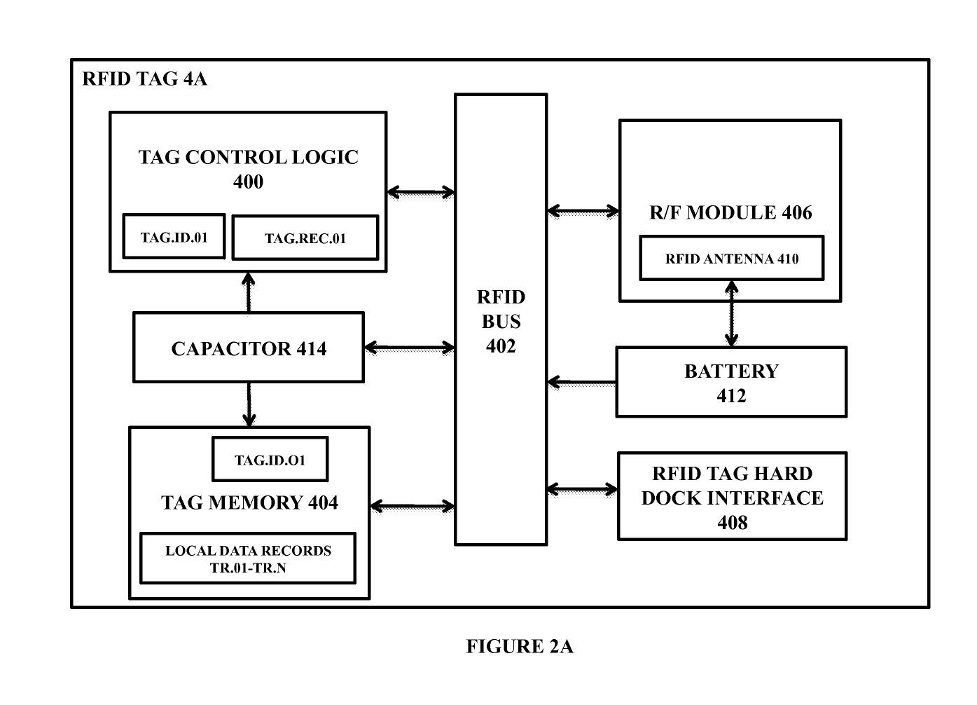

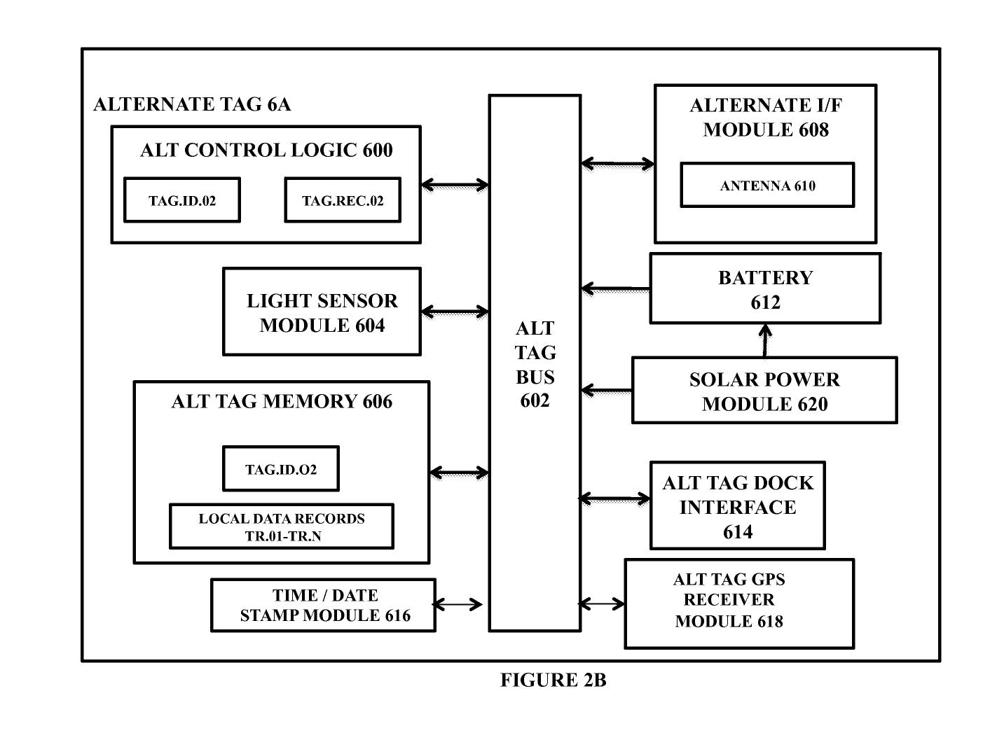

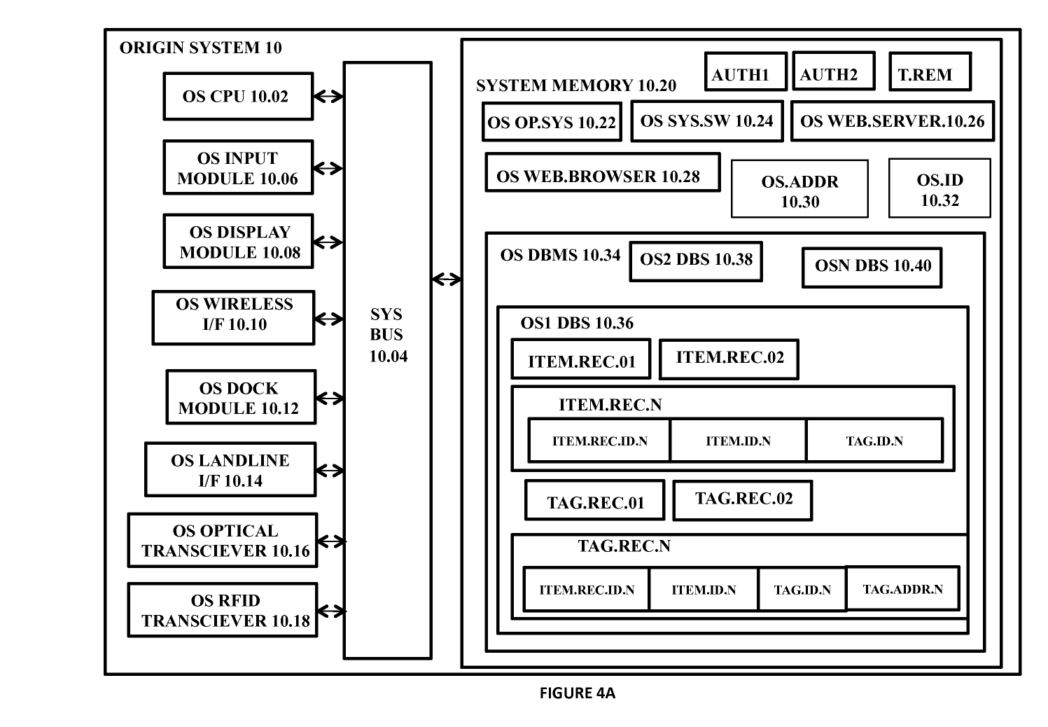

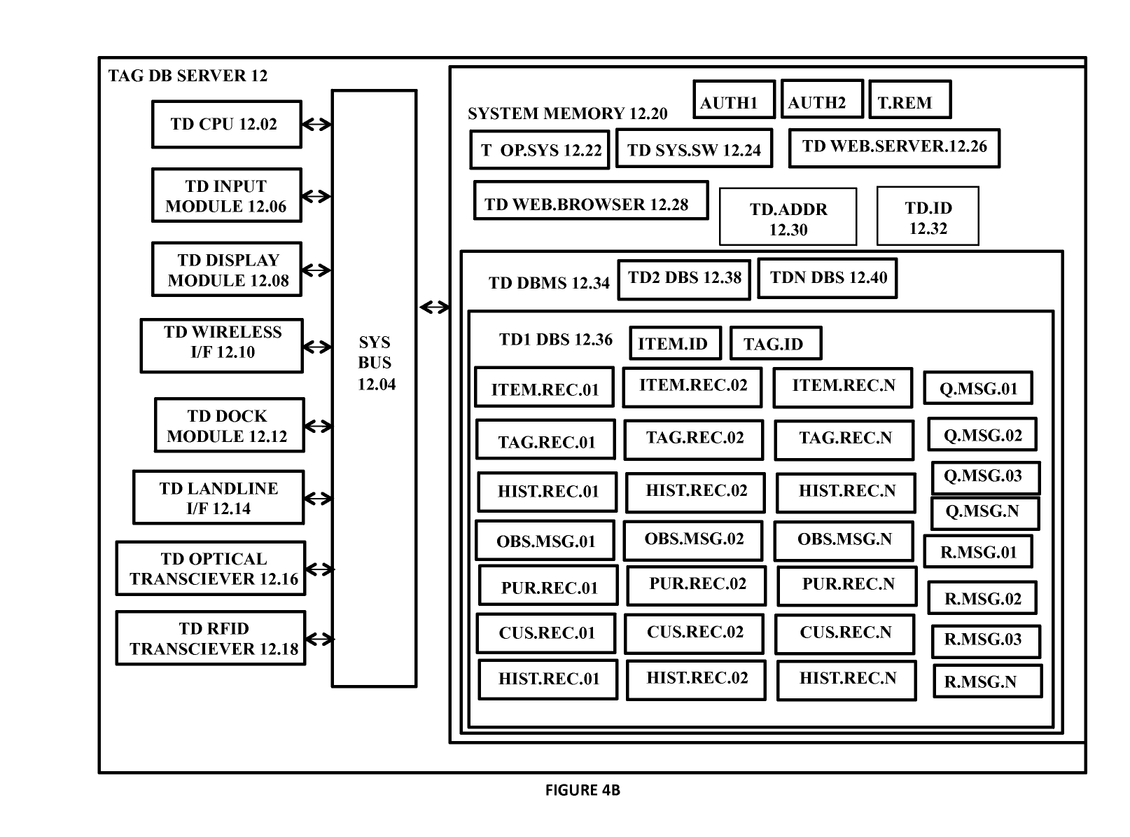

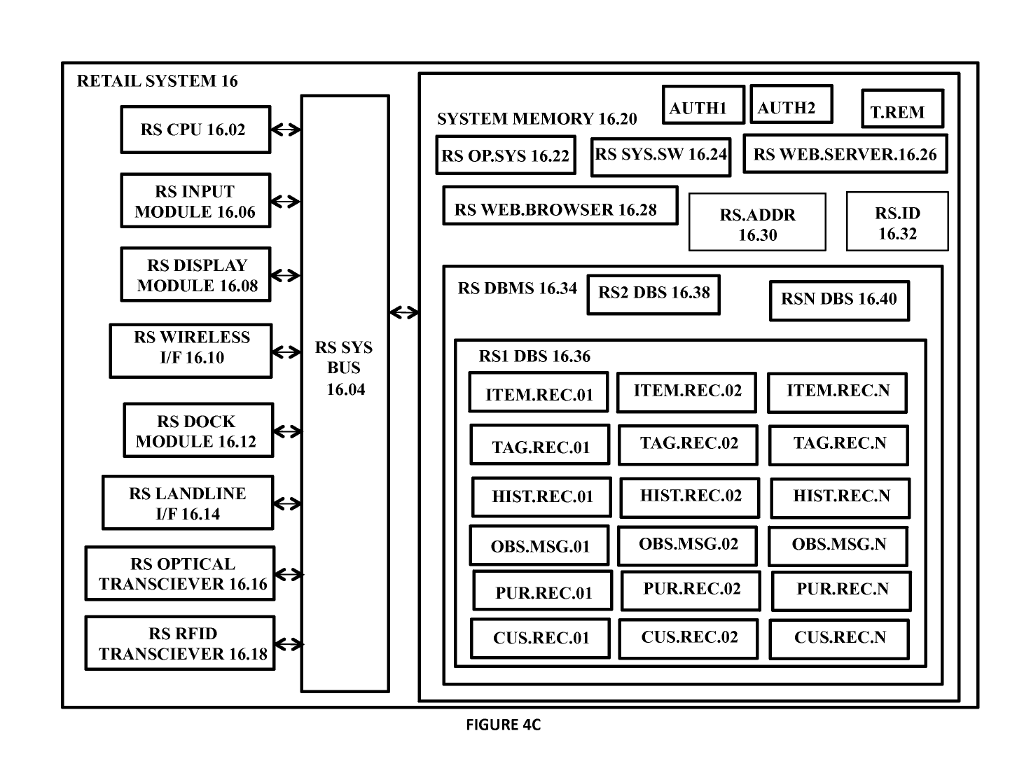

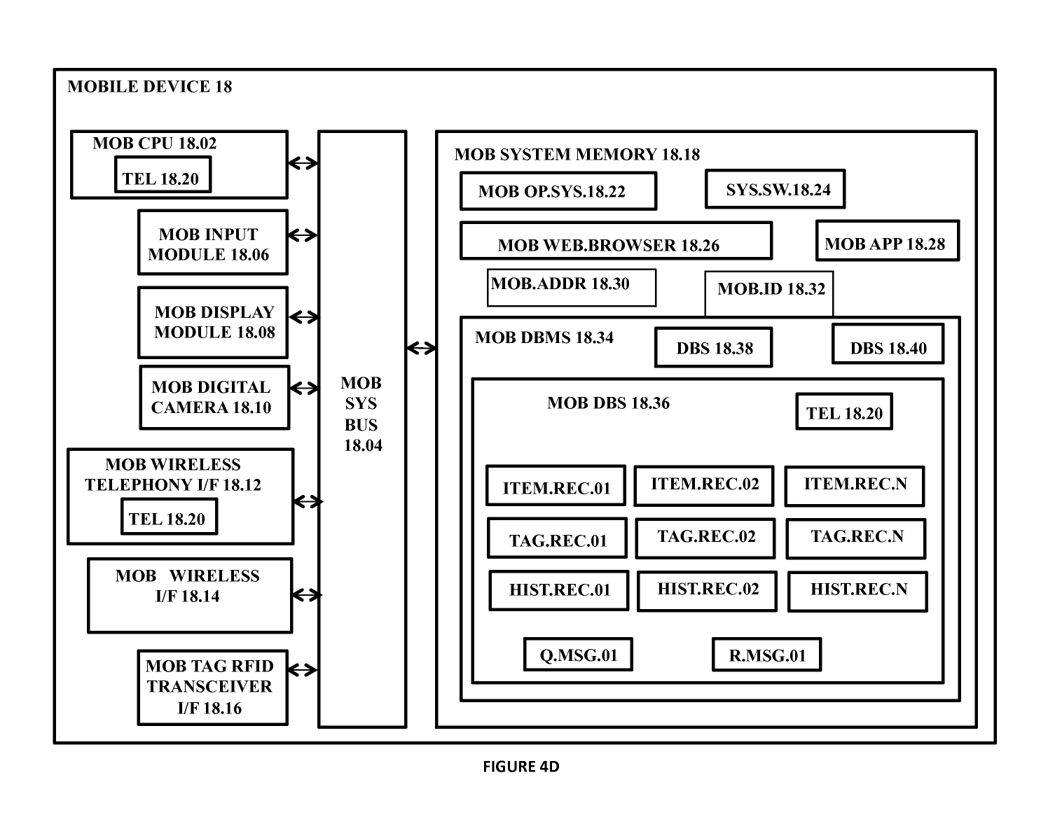

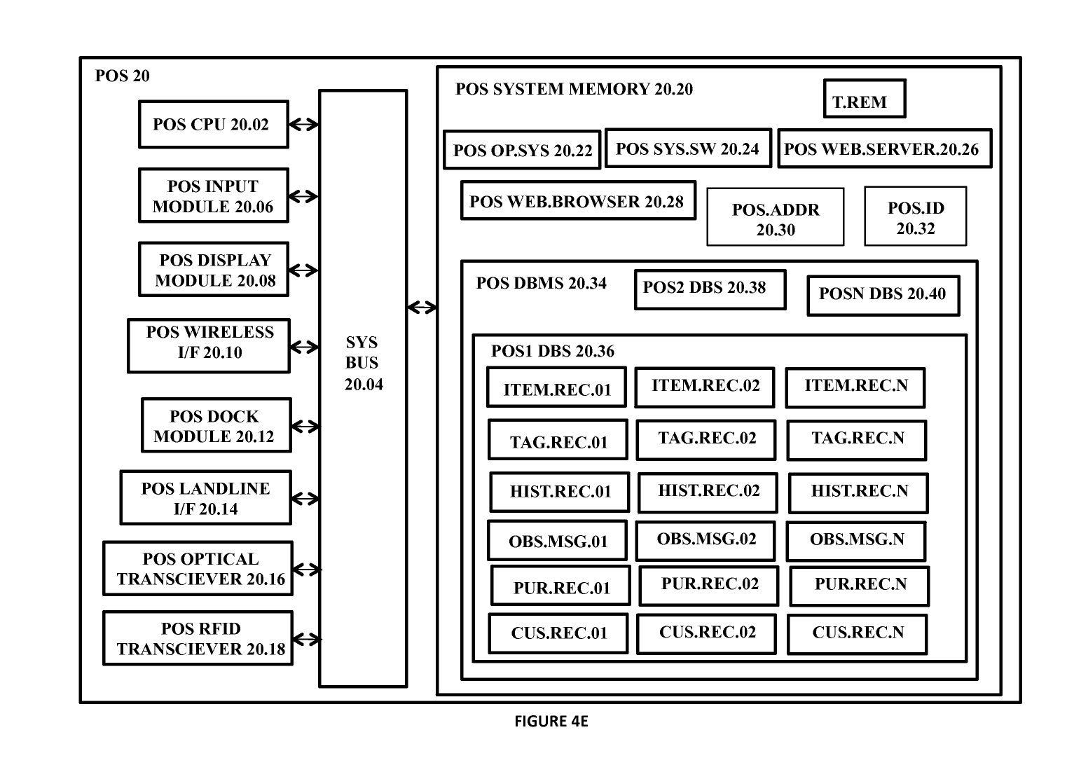

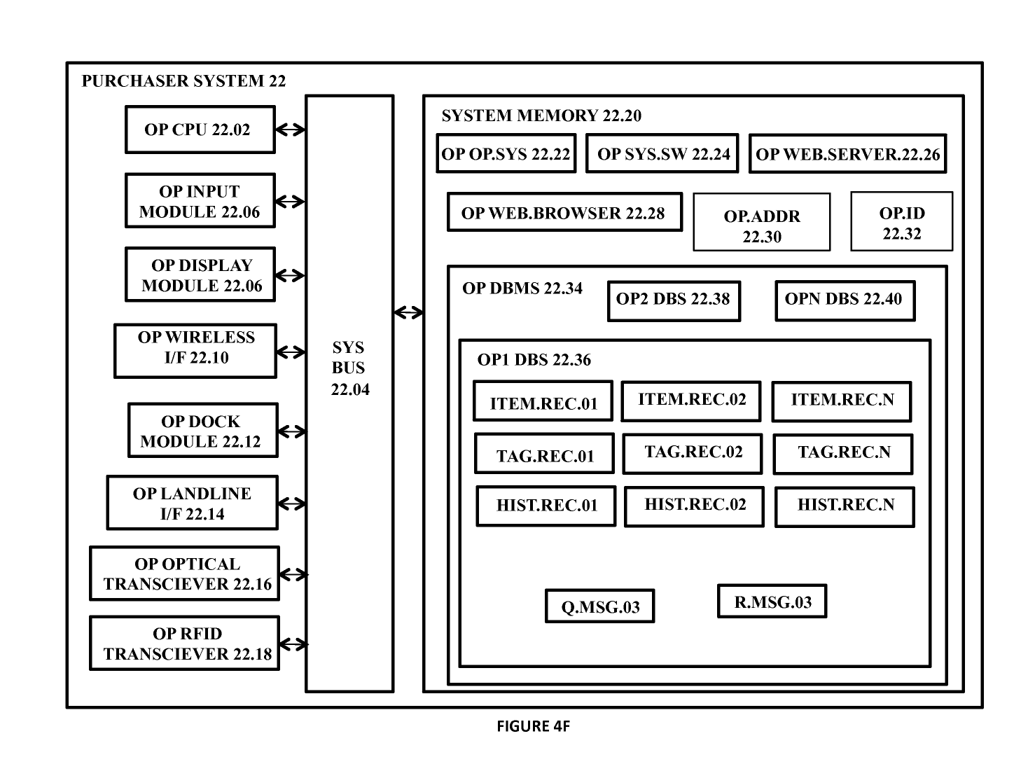

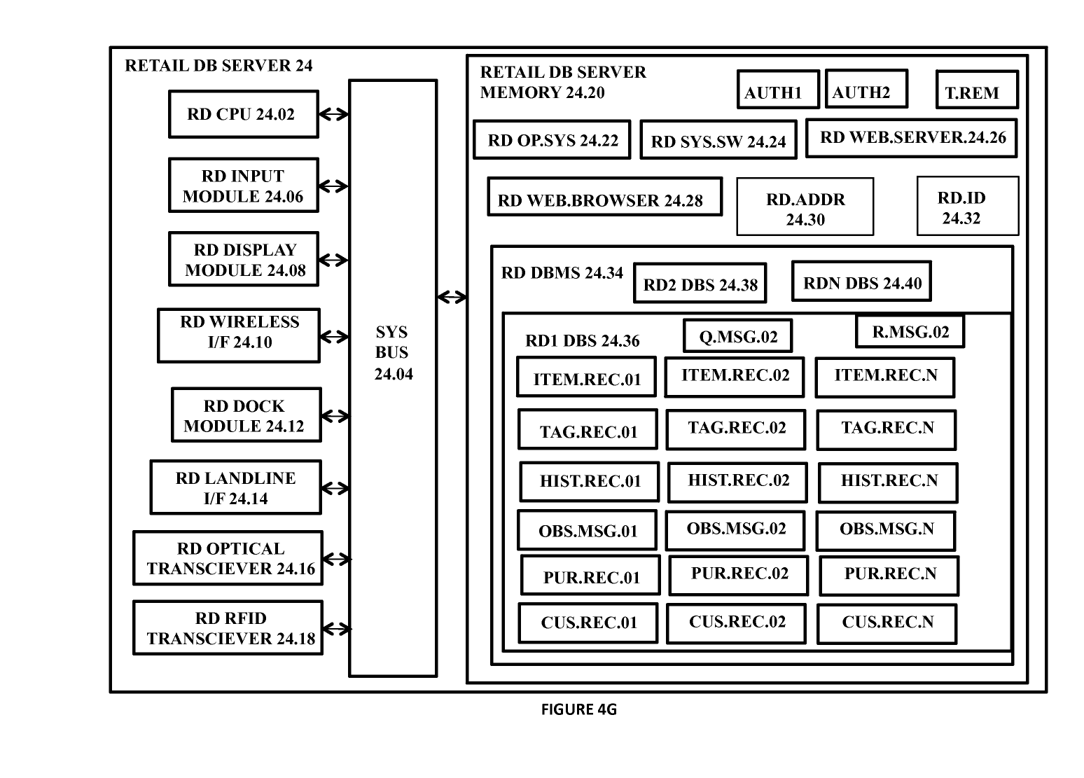

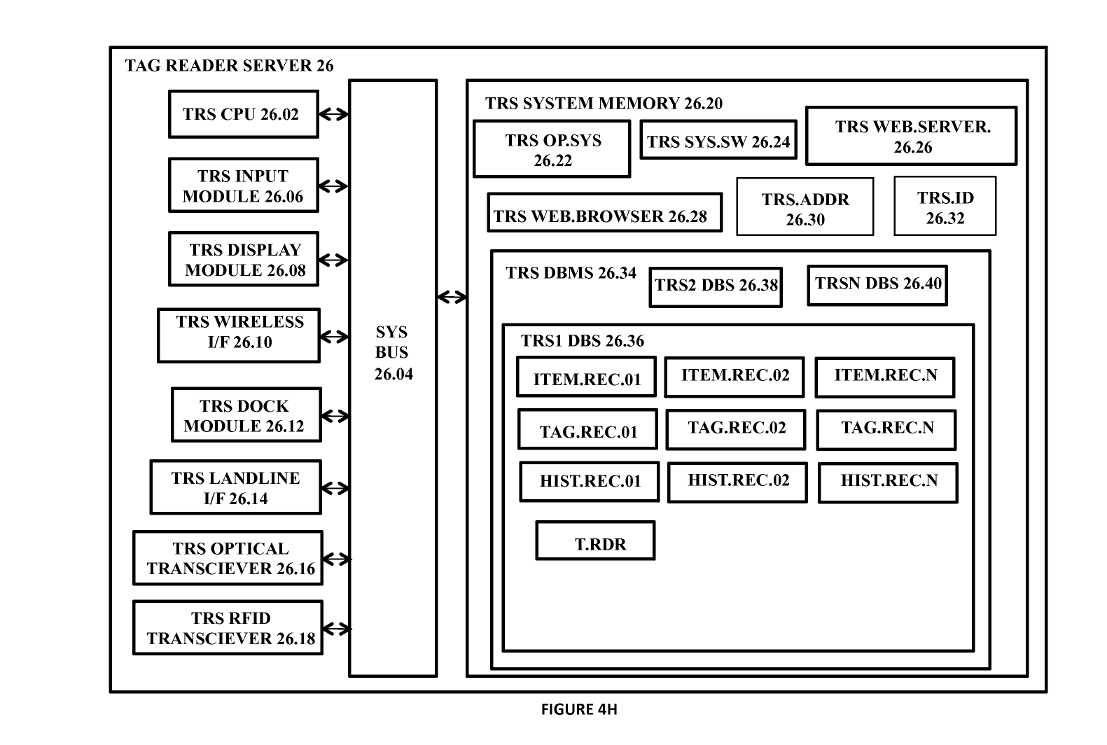

The originating computer system 10 (hereinafter “origin system 10”) is preferably adapted to write tag information into the tag devices 4A-4N & 6A-6N by an originating wireless communications module 10A and or by means of a hardware dock 10B, as presented at FIGS. 4A through 4C and FIGS. 4E through 4F. The origin system 10 is preferably located proximate to a point of shipment origin of an item ITEM.01-ITEM.N that is associated with at least the basic label 300 of FIGS. 3A through 3F and optionally comprising a tag device 4A-4N & 6A-6N (as presented in FIGS. 2A, 2B and 3C through 3F), whereby information regarding the instant item ITEM.01-ITEM.N may be written into the associated tag device 4A-4N & 6A-6N, and/or represented on the basic label 300 coupled with the associated tag device 4A-4N & 6A-6N, at a location of the origin of the instant item ITEM.01-ITEM.N, e.g., (a.) at a farm or ranch where the item ITEM.01-ITEM.N comprises a food portion, (b.) at a fabrication site where the item ITEM.01-ITEM.N comprises a manufactured good, or (c.) at an extraction site where the ITEM.01-ITEM.N comprises a material, substance or a natural resource. The origin server 12 receives and optionally provides information related to each of a plurality of tag devices 4A-4N & 6A-6N via the interconnection 8 to the tag database server 12 (hereinafter, “the tag DB server 12”).

The plurality of tag readers 14A-14N are preferably positioned along the stream of commerce that is formed between a shipment of the associated item ITEM.01-ITEM.N from a location of origin and to retail sales location at which the point of sale computer system 20 (hereinafter, “POS 20”) is located. Each tag reader 14A-14N is preferably adapted provide information read from each of the plurality of tag devices 6A-6N & 8.A-8.N to the tag DB server 12 via the interconnection 8. Alternatively or additionally, one or more tag readers 14A-14N may be adapted to write information into one or more of the plurality of tag devices 6A-6N & 8.A-8.N. Still further optionally or additionally, one or more tag readers 14A-14N may be adapted to read information represented by patterns presented by one or more basic labels 300.

One or more tag readers 14A-14N may be or comprise a commercially available RFID reader device, such as a 70 Series Ultra-Rugged Mobile Computer™ RFID reader device marketed by the Intermec Corporation of Everett, Wash.; an IP30 ™ handheld RFID reader marketed by the Intermec Corporation of Everett, Wash.; a MC3190-Z™ handheld RFID reader as marketed by Motorola Solutions, Inc. of Schaumberg, Ill.; a MC9190-Z™ handheld RFID reader as marketed by Motorola Solutions, Inc. of Schaumberg, Ill.; a FX7400™ fixed RFID reader as marketed by Motorola Solutions, Inc. of Schaumberg, Ill.; a FX9500™ fixed RFID reader as marketed by Motorola Solutions, Inc. of Schaumberg, Ill.; a DS9808-R™ bar code scanner and RFID reader as marketed by Motorola Solutions, Inc. of Schaumberg, Ill.; and/or or more suitable RFID reader, bar code readers and/or QR code readers in singularity or in combination.

A retail computer system 16 (hereinafter, “the retail system 16”) is adapted to receive information from, or related to, one or more of the plurality of tag devices 4A-4N & 6A-6N from one or more tag devices 4A-4N & 6A-6N, the POS 20, the retail database server 24 and/or the tag DB server 12. Alternatively or additionally, the retail computer system 16 (hereinafter, “retail system 16”) may be adapted to write information into one or more of the plurality of tag devices 6A-6N & 8.A-8.N. Still further optionally or additionally, the retail system 16 may be adapted to read information represented by patterns presented by one or more basic labels 300.

The mobile consumer communications device 18 (hereinafter, “mobile device 20”) is preferably adapted to receive information from one or more tags of the plurality of tag devices 6A-6N & 8.A-8.N and/or access information related to one or more tags of the plurality of tag devices 6A-6N & 8.A-8.N from at least one tag device 6A-6N & 8.A-8.N, the retail system 16, the retail database server 24 and/or the tag DB server 12. Optionally, alternatively or additionally, the mobile device 20 may be adapted to read information represented by patterns presented by one or more basic labels 300. By this aspect of the invented method, a potential purchaser may preferably access information related to the item ITEM.01-ITEM.N associated with the instant tag device 6A-6N & 8.A-8.N prior to making a purchase of the associated item ITEM.01-ITEM.N and possibly while the potential purchaser is present at a retail sales location at which the POS 20 is located.

The POS 20 is preferably adapted to read information from one or more tags of the plurality of tag devices 6A-6N & 8.A-8.N and/or access information related to one or more tags of the plurality of tag devices 6A-6N & 8.A-8.N from at least one tag device 6A-6N & 8.A-8.N, the retail system 16, the retail database server 24 and/or the tag DB server 12.

The purchaser computer system 22 is preferably adapted to read information from one or more tags of the plurality of tag devices 6A-6N & 8.A-8.N and/or access information related to one or more tags of the plurality of tag devices 6A-6N & 8.A-8.N from the retail computer system 16, the retail database server 24 and/or the tag DB server 12. By this aspect of the invented method, a purchaser of an item ITEM.01-ITEM.N may preferably access information related to the purchased item ITEM.01-ITEM.N associated with a tag device 6A-6N & 8.A-8.N after making a purchase of the associated item ITEM.01-ITEM.N and optionally providing information about the instant purchased item ITEM.01-ITEM.N to retail computer system 16, the retail database server 24 and/or the tag DB server 12. It is understood that the mobile device 20 may alternatively or additionally employed the purchaser of an item ITEM.01-ITEM.N may preferably access information related to the purchased item ITEM.01-ITEM.N associated with a tag device 6A-6N & 8.A-8.N after making a purchase of the associated item ITEM.01-ITEM.N and optionally providing information about the instant purchased item ITEM.01-ITEM.N to retail system 16, the retail database server 24 and/or the tag DB server 12. Optionally, alternatively or additionally, the purchaser system 22 may be adapted to read information represented by patterns presented by one or more basic labels 300.

The retail database server 24 (hereinafter, “retail DB server 24”) is adapted to receive information from, or related to, one or more of the plurality of tag devices 4A-4N & 6A-6N from one or more tag devices 4A-4N & 6A-6N, the origin system 10, the POS 20, the retail DB server 24 and/or the tag DB server 12. Alternatively or additionally, the retail DB server 24 may be adapted to write information into one or more of the plurality of tag devices 6A-6N & 8.A-8.N. Still further optionally or additionally, the retail system 16 may be adapted to read information represented by patterns presented by one or more basic labels 300.

The optional tag reader server 26 (hereinafter, “reader server 26”) is adapted to facilitate communications between one or more tag readers 14A-14N and one or more devices, systems and/or servers 8-12 & 16-26 of the network 2.

The origin system 10, tag DB server 12, the retail system 16, the POS 20, second purchaser system 22, the retail DB server 24 and/or the optional reader server 26 may be or comprise (a.) a network-communications enabled THINKSTATION WORKSTATION™ notebook computer marketed by Lenovo, Inc. of Morrisville, N.C.; (b.) a NIVEUS 5200 computer workstation marketed by Penguin Computing of Fremont, Calif. and running a LINUX™ operating system or a UNIX™ operating system; (c.) a network-communications enabled personal computer configured for running WINDOWS XP™, VISTA™ or WINDOWS 7 ™ operating system marketed by Microsoft Corporation of Redmond, Wash.; (d.) a MACBOOK PRO™ personal computer as marketed by Apple, Inc. of Cupertino, Calif.; or (e.) other suitable mobile electronic device, wireless communications device, computational system or electronic communications device known in the art.

The mobile device 18 may be or comprise (a.) an IPAD™ tablet computer as marketed by Apple, Inc. of Cupertino, Calif.; (b.) an IPHONE™ cellular telephone as marketed by Apple, Inc. of Cupertino, Calif.; (c.) an HTC TITAN II™ cellular telephone as marketed by AT&T, Inc. of Dallas, Tex. and running a WINDOWS 7 ™ operating system as marketed by Microsoft Corporation of Redmond, Wash.; (d.) a GALAXY NEXUS™ smart phone as marketed by Samsung Group of Seoul, Republic of Korea or and running an ANDROID™; (e.) a TOUGHPAD™ tablet computer as marketed by Panasonic Corporation of Kadoma, Osaka, Japan and running an ANDROID™ operating system as marketed by Google, Inc. of Mountain View, Calif.; or (f.) other suitable mobile electronic device, wireless communications device, computational system or electronic communications device known in the art.

Referring now generally to the Figures and particularly to FIG. 2A, FIG. 2A is a schematic drawing of an exemplary first radio frequency identification device 4A. The word “exemplary” is used herein to mean serving as an example, instance, or illustration. The subject matter disclosed herein is not limited by such examples. In addition, any aspect or design described herein as “exemplary” is not necessarily to be construed as preferred or advantageous over other aspects or designs.

The first radio frequency identification device 4A, or “first RFID tag 4A”, includes a tag control logic 400 that is bi-directionally communicatively coupled by an RFID power and communications bus 402 to a tag memory circuit 404 a radio frequency communications module 406 and an optional hard dock interface 408. The radio frequency communications module 406 comprises an antenna 410 that receives both (a.) electromagnetic wave energy that includes information and (b.) electromagnetic wave energy that provides electrical energy, wherein the antenna 410 transfers at least a portion of the received electromagnetic wave energy to a battery 412. The battery 412 is adapted to provide electrical energy to the tag control logic 400, the tag memory circuit 404, a radio frequency communications module 406, the optional device hard dock interface 408 and an optional capacitor 414 via the RFID power and communications bus 402. The optional capacitor is adapted to store electrical energy and then provide the stored electrical energy directly to the tag control logic 400 and/or the tag memory 404.

The tag control logic 400 may be programmable, configurable, reprogrammable and/or reconfigurable to comprise instructions that enable the first RFID tag 4A to operate in accordance with one, more than one, or all aspects the invented method. A plurality of local tag records TR.01-TR.N may be stored in the solid-state electronic tag memory 404. The device hard dock interface 408 is adapted to enable the first RFID tag 2 to mechanically couple with the origin system 10, the retail system 16, the mobile device 18, the POS 20, the purchaser system 22, the retail DB server 24 and/or the tag DB server 12 to enable bi-directional information transfer to and from the first RFID tag 4A.

A first RFID tag identifier TAG.ID.01 uniquely identifies the first RFID tag 4A to at least the tag database server 12 and may be stored within the first RFID tag 4A at the tag control logic 400 and/or the tag memory 404. It is further understood that the first RFID tag identifier TAG.ID.01 may be written into a read only memory, a one time programmable register, and/or a reprogrammable logic element of the tag control logic 400. It is further understood that the tag control logic 400 may be distributed as separate elements that are individually communicatively coupled with the RFID bus 402.

It is understood that one, more than one or all aspects or elements 400-412 & TR.01-TR.N of the first RFID tag 4A may be comprised within one or more tag devices 4B-4N AND/or alternate tag devices 6A-6N.

Referring now generally to the Figures and particularly to FIG. 2B, FIG. 2B is a schematic drawing of an exemplary first alternate tag device 4B. The first alternate tag device 6A, or “first alternate tag device 6A”, includes a control logic 600 that is bi-directionally or uni-directionally communicatively coupled by an alternate power and communications bus 602 to a light sensor module 604, an alternate tag memory circuit 606 and an alternate interface communications module 608. The alternate interface communications module 608 comprises an antenna 610 that receives electromagnetic wave energy that includes information. The optional light sensor module 604 is adapted to receive and extract information, optionally as directed by the alternate control logic 600, from electromagnetic light wave energy signals.

An alternate battery 612 is adapted to provide electrical energy to the alternate control logic 600, the light sensor module 604, the alternate tag memory circuit 606, the alternate interface communications module 608, the RFID antenna 610, the alternate tag dock interface 614, the optional time date stamp module and/or the optional global positioning receiver module 618 via the alternate power and communications bus 602. An optional solar power module 620 is adapted to convert light energy into electrical energy, and may be coupled within the first alternate tag device 600 to deliver electrical energy to the directly to the battery 612, or alternately or additionally to alternate control logic 600, the light sensor module 604, the alternate tag memory circuit 606, the alternate interface communications module 608, the RFID antenna 610, the alternate tag dock interface 614, the optional time date stamp module, the optional global positioning receiver module 618 and/or the battery 612 via the alternate power and communications bus 602.

The alternate control logic 600 may be programmable, configurable, reprogrammable and/or reconfigurable to comprise instructions that enable the first alternate tag device 6A to operate in accordance with one, more than one, or all aspects the invented method. A plurality of local tag records TR.01-TR.N may be stored in the solid-state electronic alternate tag memory 606. It is understood that one, more than one or all aspects or elements 600-618 & TR.01-TR.N of the first alternate tag device 6A may be comprised within one or alternate tag devices 6B-6N or RFID tag devices 4A-4N.

A first alt tag identifier TAG.ID.02 uniquely identifies the first alternate tag device 6A to at least the tag database server 12 and may be stored within the first alternate tag device 6A at the alternate control logic 600 and/or the alternate tag memory 606. It is further understood that the first alternate tag identifier TAG.ID.02 may be written into a read only memory, a one time programmable register, and/or a reprogrammable logic element of the alternate control logic 600. It is further understood that the alternate control logic 600 may be distributed as separate elements that are individually communicatively coupled with the alternate tag bus 602.

It is understood that the numerical designation of “N” in reference to tag indications 4N and 6N indicates the potential of an arbitrarily large multiplicity of individually unique, separate and distinguishable tag devices 4A-4N and 6A-6N, wherein the number of tag devices 4A-4N and 6A-6N may be limited by resource, design and market-determinate constraints. It is further understood that variations of certain tag devices 4A-4N & 6A-6N may comprise any aspect, element or feature 400-408 & 600-618 of any tag 4A-4N & 6A-6N as disclosed herein.

The time date stamp generation module 616 may comprise a real time clock circuit and is adapted to generate time and date data that the alternate tag 14A writes into local records TR.1-TR.N and/or transmits to one or more readers 14A-14N and/or systems and/or servers 10-26 of the network 2.

The alternate tag global positioning system receiver 6.18 (hereinafter, “alternate tag GPS receiver 6.18”) is adapted to receive geolocational signals from the Global Positioning System (hereinafter, “GPS”) space-based satellite navigation system that is maintained by the government of the United States and provides location and time information. The alternate tag GPS receiver 6.18 is further adapted to derive and generate geolocational GPS data from signals received from the GPS.

Referring now generally to the Figures and particularly to FIG. 3A and FIG. 3B, FIG. 3A is a front view of an illustration of a basic label 300 that comprises and presents a bar code image 302 and/or a quick response code image 304 that may be read by one or more readers 14A-14N. The bar code image 302 and/or a quick response code image 304, (or “QR” code image 304) are presented on a front side 306 of a material 308 as indicated on FIG. 3B, wherein the material 308 may be or comprise paper, polymer, cloth, metal, or other suitable material known in the art.

The bar code image 302 and/or a quick response code image 304 preferably comprise an encoded and unique tag identifier TAG.ID.01-TAG.ID.N that is referenced by at least the tag DB server 12 and/or the retail DB server 24 to an item identifier ITEM.ID.01-ITEM.ID.N. The bar code image 302 and/or a quick response code image 304 may optionally, alternatively or additionally comprise an encoding of a Universal Product Code that applies to an item ITEM.01-ITEM.N that is associated with the tag identifier TAG.ID.01-TAG.ID.N that is both (a.) encoded in bar code image 302 and/or a quick response code image 304 and (b.) related to the item ITEM.01-ITEM.N by the tag DB server 12. The basic label 300 is preferably directly attached to a first container 310 that in combination with a plurality of strawberries 312 comprises a first item ITEM.01.

FIG. 3B is a side view of the basic label 300 showing an adhesive 314 attached to a back side 316 of the material 308, wherein the adhesive 314 and the material 308 are selected to maintain a coupling of the basic label 300 with the first container 310 in transit through the stream of commerce and after retail purchase by an end user.

FIG. 3C is a perspective view of a first tag label 311 that includes the basic label 300 the first RFID tag 4A wherein the first tag label 311 is attached to a first alternate container 318 that contains a volume of spring water 320. The spring water 320 and the first alternate container 318 are combined together to form a second item ITEM.02.

FIG. 3D is a side view of the first tag label 311 wherein the first tag label 311 includes the first RFID tag 4A in combination with the basic label 300 and a tag adhesive 322. The tag adhesive 322 is selected to maintain a coupling of the first RFID tag 4A with the basic label 300 in transit through the stream of commerce and after retail purchase by an end user.

FIG. 3E is a perspective view of a second tag label 323 comprising the basic label 300, the first alternate tag device 6A and the tag adhesive 322. The second tag label 323 is attached to a third cubic container 324 by the adhesive 314, wherein the third container 324 encloses a cubic device 326. The third container 324 and the cubic device 326 in combination form a third ITEM.03.

It is understood that and a multiplicity of N labels 300, 311 & 323 may each be separately attached to each of a multiplicity of N items ITEM.01-ITEM.N, to which one or more tag devices 4A-4N & 6A-6N of a multiplicity of N RFID tag devices 4A-4N or a multiplicity of N alternate tag devices 6A-6N may be coupled.

FIG. 3F is a side view of the second tag label 323, wherein the first alternate tag device 6A as attached by the tag adhesive 322 to the basic tag 300.

FIG. 3G is a perspective view of the second tag label 323 directly coupled with the cubic device 326. It is understood that an item ITEM.01-ITEM.N may be shipped without a container, with wrapping (not shown) and/or without wrapping and that labels 300, 311 & 323 may alternatively be attached within a container, to wrapping, or directly to a good. The cubic device 326 is shown in FIG. 3G to be an Nth item ITEM.N by itself and without a container or wrapping.

FIG. 3H is a perspective view of the first alternate tag device 6A placed among strawberries and without adhesive attachment, whereby is shown that an item ITEM.01-ITEM.N may be shipped without the basic label and with a tag 4A-4N & 6A-6N.

Referring now to FIG. 4A, FIG. 4A is a schematic diagram of the origin system 10. The origin system 10 includes an origin system (“OS”) central processing unit 10.02 (hereinafter, “CPU 10.02”) that is bi-directionally communicatively coupled to by an OS system communications bus 10.04 to an OS user input module 10.06, an OS display module 10.08, and OS wireless communications interface 10.10, an OS dock module 10.12, an OS landline communications bi-directional interface 10.14, an OS optical communications transceiver 10.16, an OS radio frequency identification device transceiver 10.18, and an OS system memory 10.20.

The OS user input module 10.06 may include a computer keyboard, a computer mouse and/or other human-to-computer input devices that enable a human user to input data, queries and commands to the origin system 10. The OS display module 10.08 is adapted to visually render data, images and other representations of other information as output by or by means of the origin system 10 for perception by a human operator. The OS wireless interface 10.10 enables the bi-directional communications between the origin system 10 and (a.) the interconnection 8; and (b.) the alternate tag 4A, wherein the OS wireless interface may be adapted to communicate in accordance with a BLUETOOTH™ communications standard or other suitable wireless communications standards or protocols. The OS dock module 10.12 is adapted to physically connect with the RFID tag hard dock interface 408 and/or the alt tag hard dock interface and enable bi-directional communications between the OS system 10 and the docked tag 4A & 6A. The OS landline interface 10.14 enables the bi-directional communications between the origin system 10 and the interconnection 8 via a landline connection (not shown) of the interconnection 8, such as a connector assembly conforming to an Ethernet™ communications connector standard or other suitable connector standards known in the art. The OS optical transceiver 10.16 enables the bi-directional light energy communications between the origin system 10 and (a.) a light sensing transceiver (not shown) of the interconnection 8; and/or (b.) the light sensor module of the energy 604 alternate tag 4A. The OS RFID transceiver 10.18 enables the both bi-directional communications between the origin system 10 and the RFID tag 4A and the provision of electrical energy to the RFID tag 4A via the RFID antenna 410.

The OS system memory 10.20 stores a plurality of software encoded information, instructions and records, to include an OS software operating system 10.22, an OS system software 10.24, an OS web server 10.26, and OS web browser 10.28, an OS network address 10.30, a unique origin system identifier OS.ID 10.32, and an OS database management system OS DBMS 10.34. The OS software operating system 10.22 enables the origin system 10 to perform basic and essential computational tasks, such as scheduling tasks, executing applications, and controlling peripherals. The OS system software 10.24 provides software-encoded instructions, data and information that enables the origin system to perform in accordance with the aspects of the method of the present invention. The OS web server 10.26 enables the origin system 10 to generate and transmit web pages via the interconnection 8 to web browsers of systems and servers 8, 12, 16-26. The OS web browser 10.28 enables the origin system 10 to render received web pages. The OS network address 10.30 is a unique identifier that may be used to identify the origin system 10 as a sender or intended recipient of an electronic message. The OS.ID 10.32 uniquely identifies the origin system 10 to the network 2 and elements, systems and servers 8 & 12-26 thereof. The OS DBMS 10.34 stores one or more databases 10.36-10.40 that may each store electronic records, and/or representations of addresses messages and information.

The OS system memory 10.20 may optionally store a first authorization code AUTH1 and/or a second authorization code AUTH2 that may be used by the origin system 10 to verify the inclusion of the first authorization code AUTH1 and/or a second authorization code AUTH2 in query messages Q.MSG.01-Q.MSG.N received by the origin system 10.

Referring now to FIG. 4B, FIG. 4B is a schematic diagram of the tag DB server 12. The tag DB server 12 includes a tag DB server (“TD”) central processing unit 12.02 (hereinafter, “TD CPU 12.02”) that is bi-directionally communicatively coupled to by a TD system communications bus 12.04 to a TD user input module 12.06, a TD display module 12.08, a TD wireless communications interface 12.10, a TD dock module 12.12, a TD landline communications bi-directional interface 12.14, a TD optical communications transceiver 12.16, a TD radio frequency identification device transceiver 12.18, and a TD system memory 12.20.

The TD user input module 12.06 may include a computer keyboard, a computer mouse and/or other human-to-computer input devices that enable a human user to input data, queries and commands to the tag DB server 12. The TD display module 12.08 is adapted to visually render data, images and other representations of other information as output by or by means of the tag DB server 12 for perception by a human operator. The TD wireless interface 12.10 enables the bi-directional communications between the tag DB server 12 and (a.) the interconnection 8; and (b.) the alternate tag 4A, wherein the TD wireless interface may be adapted to communicate in accordance with a BLUETOOTH™ communications standard or other suitable wireless communications standards or protocols. The TD dock module 12.12 is adapted to physically connect with the RFID tag hard dock interface 408 and/or the alt tag hard dock interface and enable bi-directional communications between the tag DB server 12 and the docked tag 4A & 6A. The TD landline interface 12.14 enables the bi-directional communications between the tag DB server 12 and the interconnection 8 via a landline connection (not shown) of the interconnection 8 such as a connector assembly conforming to an Ethernet™ communications connector standard or other suitable connector standards known in the art. The TD optical transceiver 12.16 enables the bi-directional light energy communications between the tag DB server 12 and (a.) a light sensing transceiver (not shown) of the interconnection 8; and/or (b.) the light sensor module 604 of the alternate tag 6A. The TD RFID transceiver 12.18 enables the both bi-directional communications between the tag DB server 12 and the RFID tag 4A and the provision of electrical energy to the RFID tag 4A via the RFID antenna 410.

The TD system memory 12.20 stores a plurality of software encoded information, instructions and records, to include a TD software operating system 12.22, a TD system software 12.24, a TD web server 12.26, and TD web browser 12.28, a TD network address 12.30, a unique tag DB server identifier TD.ID 12.32 and a TD database management system TD DBMS 12.34. The TD software operating system 12.22 enables the tag DB server 12 to perform basic and essential computational tasks, such as such as scheduling tasks, executing applications, and controlling peripherals. The TD system software 12.24 provides software-encoded instructions, data and information that enables the tag DB server to perform in accordance with the aspects of the method of the present invention. The TD web server 12.26 enables the tag DB server 12 to generate and transmit web pages via the interconnection 8 to web browsers of systems and servers 8, 10 & 16-26. The TD web browser 12.28 enables the tag DB server 12 to render received web pages. The TD network address 12.30 is a unique identifier that may be used to identify the tag DB server 12 as a sender or intended recipient of an electronic message. The TD identifier 12.32 uniquely identifies the tag DB server 12 to the network 2 and elements, systems and servers 8, 10 & 16-26 thereof. The TD DBMS 12.34 stores one or more databases 12.36-12.40 that may each store electronic records, and/or representations of addresses messages and information.

The tag DB server system memory 12.20 may optionally store a first authorization code AUTH1 and/or a second authorization code AUTH2 that may be used by the tag DB server 12 to verify the inclusion of the first authorization code AUTH1 and/or a second authorization code AUTH2 in query messages Q.MSG.01-Q.MSG.N received by the tag DB server 12.

Referring now to FIG. 4C, FIG. 4C is a schematic diagram of the retail system 16. The retail system 16 includes a retail system (“RS”) central processing unit 16.02 (hereinafter, “RS CPU 16.02”) that is bi-directionally communicatively coupled to by an RS system communications bus 16.04 to an RS user input module 16.06, an RS display module 16.08, an RS wireless communications interface 16.10, an RS dock module 16.12, an RS landline communications bi-directional interface 16.14, an RS optical communications transceiver 16.16, an RS radio frequency identification device transceiver 16.18, and an RS system memory 16.20.

The RS user input module 16.06 may include a computer keyboard, a computer mouse and/or other human-to-computer input devices that enable a human user to input data, queries and commands to the retail system 16. The RS display module 16.08 is adapted to visually render data, images and other representations of other information as output by or by means of the retail system 16 for perception by a human operator. The RS wireless interface 16.10 enables the bi-directional communications between the retail system 16 and (a.) the interconnection 8; and (b.) the alternate tag 4A, wherein the RS wireless interface may be adapted to communicate in accordance with a BLUETOOTH™ communications standard or other suitable wireless communications standards or protocols. The RS dock module 16.12 is adapted to physically connect with the RFID tag hard dock interface 408 and/or the alt tag hard dock interface 614 and thereby enable bi-directional communications between the retail system 16 and the docked tag 4A & 6A. The RS landline interface 16.14 enables the bi-directional communications between the retail system 16 and the interconnection 8 via a landline connection (not shown) of the interconnection 8, such as a connector assembly conforming to an Ethernet™ communications connector standard or other suitable connector standards known in the art. The RS optical transceiver 16.16 enables the bi-directional light energy communications between the retail system 16 and (a.) a light sensing transceiver (not shown) of the interconnection 8; and/or (b.) the light sensor module of the energy 604 alternate tag 4A. The RS RFID transceiver 16.18 enables the both bi-directional communications between the retail system 16 and the RFID tag 4A and the provision of electrical energy to the RFID tag 4A via the RFID antenna 410.

The RS system memory 16.20 stores a plurality of software encoded information, instructions and records, to include an RS software operating system 16.22, an RS system software 16.24, an RS web server software 16.26, an RS web browser, an RS network address 16.30, a unique retail system identifier RS.ID 16.32 and an RS database management system RS DBMS 16.34. The RS software operating system 16.22 enables the retail system 16 to perform basic and essential computational tasks, such as scheduling tasks, executing applications, and controlling peripherals. The RS system software 16.24 provides software-encoded instructions, data and information that enables the retail system 16 to perform in accordance with the aspects of the method of the present invention. The RS web server 16.26 enables the retail system 16 to generate and transmit web pages via the interconnection 8 to web browsers of systems and servers 8-12, 18-26. The RS web browser 16.28 enables the retail system 16 to render received web pages. The RS network address 16.30 is a unique identifier that may be used to identify the retail system 16 as a sender or intended recipient of an electronic message. The RS.ID 16.32 uniquely identifies the retail system 16 to the network 2 and elements, systems and servers 8-12 & 18-26 thereof. The RS DBMS 16.34 stores one or more databases 16.36-16.40 that may each store electronic records, and/or representations of addresses messages and information.

The retail system memory 16.20 may optionally store the first authorization code AUTH1 and/or the second authorization code AUTH2 and the retail system 16 may include the first authorization code AUTH1 and/or the second authorization code AUTH2 in query messages Q.MSG.01-Q.MSG.N. Alternatively or additionally, the first authorization code AUTH1 and/or the second authorization code AUTH2 may be accessed by the retail system 16 to verify the inclusion of the first authorization code AUTH1 and/or a second authorization code AUTH2 in query messages Q.MSG.01-Q.MSG.N received by the retail system 16.

Referring now generally to the Figures and particularly to FIG. 4D, FIG. 4D is a schematic diagram of the mobile device 18. The mobile device 18 includes a mobile device central processing unit 18.02 (hereinafter, “MOB CPU 18.02”) that is bi-directionally communicatively coupled to by a MOB system communications bus 18.04 to a MOB user input module 18.06, a MOB display module 18.08, a MOB digital camera 18.10, a MOB wireless telephony communications interface 18.12, a wireless communications transceiver 18.14, a MOB radio frequency identification device transceiver 18.16, and a MOB system memory 18.18.

It is understood that the MOB radio frequency identification device transceiver 18.16 may be a peripheral device that is detachably coupled with the mobile device 16.

The MOB user input module 18.06 may include a touch screen, a computer keyboard, a computer mouse and/or other human-to-computer input devices that enable a human user to input data, queries and commands to the mobile device 18. The MOB display module 18.08 may comprise a touch screen is adapted to visually render data, images and other representations of other information as output by or by means of the mobile device 18 for perception by a human operator. The MOB digital camera 18.10 enables the mobile device 18 to capture, digitize and interpret the bar code 302 and the QR code 304 images from the basic label 300 in concert with other elements and aspects of the mobile device 18. The MOB wireless telephony interface 18.12 enables the bi-directional communications between the mobile device 18 and a wireless telephony network of the interconnection 8 and is addressable by reference to a mobile telephone number 18.20. The MOB wireless interface 18.14 enables the bi-directional communications between the mobile device 18, the interconnection 8 and/or the alternate tag device 6A, wherein the MOB wireless interface 18.14 may be adapted to communicate in accordance with a BLUETOOTH™ communications standard or other suitable wireless communications standards or protocols. The MOB RFID transceiver 18.16 enables the both bi-directional communications between the mobile device 18 and the RFID tag 4A and optionally the provision of electrical energy to the RFID tag 4A via the RFID antenna 410.

The MOB system memory 18.18 stores a plurality of software encoded addresses, information, instructions and records, to include the mobile telephony number 18.20, a MOB software operating system 18.22, a MOB system software 18.24, a MOB web server software 18.26, a MOB web browser 18.28, a MOB network address 18.32, a unique mobile device identifier MOB.ID 18.34 and a MOB database management system MOB DBMS 18.34. It is understood that the mobile telephony number 18.18 may alternatively or additionally be stored in the MOB CPU 18.02 and/or a MOB wireless telephony communications interface 18.12.

The MOB software operating system 18.22 enables the mobile device 18 to perform basic and essential computational tasks, such as scheduling tasks, executing applications, and controlling peripherals. The MOB system software 18.24 provides software-encoded instructions, data and information that enables the mobile device 18 to perform in accordance with the aspects of the method of the present invention, such as interpreting digital camera signals derived from bar code and QR image detection. The MOB web server 18.26 enables the mobile device 18 to generate and transmit web pages via the interconnection 8 to web browsers of systems and servers 8-12, 16, & 20-26. The MOB web browser 18.28 enables the mobile device 18 to render received web pages. The MOB network address 18.30 is a unique identifier that may be used to identify the mobile device 18 as a sender or intended recipient of an electronic message. The MOB identifier 18.32 uniquely identifies the mobile device 18 to the network 2 and elements, systems and servers 8-12, 16 & 20-26 thereof. The MOB DBMS 18.34 stores one or more databases 18.36-18.40 that may each store electronic records, and/or representations of addresses messages and information.

Referring now to FIG. 4E, FIG. 4E is a schematic diagram of the POS 20. The POS 20 includes a POS central processing unit 20.02 (hereinafter, “POS CPU 20.02”) that is bi-directionally communicatively coupled to by a POS system communications bus 20.04 to a POS user input module 20.06, a POS display module 20.08, a POS wireless communications interface 20.10, a POS dock module 20.12, a POS landline communications bi-directional interface 20.14, a POS optical communications transceiver 20.16, a POS radio frequency identification device transceiver 20.18, and a POS system memory 20.20.

The POS user input module 20.06 may include a computer keyboard, a computer mouse and/or other human-to-computer input devices that enable a human user to input data, queries and commands to the POS 20. The POS display module 20.08 is adapted to visually render data, images and other representations of other information as output by or by means of the POS 20 for perception by a human operator. The POS wireless interface 20.10 enables the bi-directional communications between the POS 20 and (a.) the interconnection 8; and (b.) the alternate tag 4A, wherein the POS wireless interface may be adapted to communicate in accordance with a BLUETOOTH™ communications standard or other suitable wireless communications standards or protocols. The POS dock module 20.12 is adapted to physically connect with the RFID tag hard dock interface 408 and/or the alt tag hard dock interface 614 and thereby enable bi-directional communications between the POS 20 and the docked tag 4A & 6A. The POS landline interface 20.14 enables the bi-directional communications between the POS 20 and the interconnection 8 via a landline connection (not shown) of the interconnection 8 such as a connector assembly conforming to an Ethernet™ communications connector standard or other suitable connector standards known in the art. The POS optical transceiver 20.16 enables the bi-directional light energy communications between the POS 20 and (a.) a light sensing transceiver (not shown) of the interconnection 8; and/or (b.) the light sensor module of the energy 604 alternate tag 4A. The POS RFID transceiver 20.18 enables the both bi-directional communications between the POS 20 and the RFID tag 4A and the provision of electrical energy to the RFID tag 4A via the RFID antenna 410.

The POS system memory 20.20 stores a plurality of software encoded information, instructions and records, to include a POS software operating system 20.22, a POS system software 20.24, a POS web server software 20.26, a POS web browser, a POS network address 20.30, a unique POS identifier RS.ID 20.32 and a POS database management system POS DBMS 20.34. The POS software operating system 20.22 enables the POS 20 to perform basic and essential computational tasks, such as scheduling tasks, executing applications, and controlling peripherals. The POS system software 20.24 provides software-encoded instructions, data and information that enables the POS 20 to perform in accordance with the aspects of the method of the present invention. The POS web server 20.26 enables the POS 20 to generate and transmit web pages via the interconnection 8 to web browsers of systems and servers 8, 10,12, 16, 18, 22, 24 & 26. The POS web browser 20.28 enables the POS 20 to render received web pages. The POS network address 20.30 is a unique identifier that may be used to identify the POS 20 as a sender or intended recipient of an electronic message. The POS.ID 20.32 uniquely identifies the POS 20 to the network 2 and elements, systems and servers 8, 10,12, 16, 18, 22, 24 & 26 thereof. The POS DBMS 20.34 stores one or more databases 20.36-20.40 that may each store electronic records, and/or representations of addresses messages and information.

Referring now to FIG. 4F, FIG. 4F is a schematic diagram of the off-site purchaser system 22 (hereinafter, “purchaser system 22”). It is understood that the purchaser system 22 is typically located away from a retail sales site where items ITEM.01-ITEM.N are purchased and may be accessed by a purchaser after purchasing an item ITEM.01-ITEM.N and for the purpose of accessing information related to both the purchased item ITEM.01-ITEM.N and to a unique tag identifier TAG.ID.01-TAG.ID.N.

The purchaser system 22 includes an OP central processing unit 22.02 (hereinafter, “POS CPU 22.02”) that is bi-directionally communicatively coupled to by an OP system communications bus 22.04 to an OP user input module 22.06, an OP display module 22.08, an OP wireless communications interface 22.10, an OP dock module 22.12, an OP landline communications bi-directional interface 22.14, an OP optical communications transceiver 22.16, an OP radio frequency identification device transceiver 22.18, and an OP system memory 22.20.

The OP user input module 22.06 may include a computer keyboard, a computer mouse and/or other human-to-computer input devices that enable a human user to input data, queries and commands to the OP 22. The OP display module 22.08 is adapted to visually render data, images and other representations of other information as output by or by means of the purchaser system 22 for perception by a human operator. The OP wireless interface 22.10 enables the bi-directional communications between the purchaser system 22 and (a.) the interconnection 8; and (b.) the alternate tag 4A, wherein the OP wireless interface may be adapted to communicate in accordance with a BLUETOOTH™ communications standard or other suitable wireless communications standards or protocols. The OP dock module 22.12 is adapted to physically connect with the RFID tag hard dock interface 408 and/or the alt tag hard dock interface 614 and thereby enable bi-directional communications between the purchaser system 22 and the docked tag 4A & 6A. The OP landline interface 22.14 enables the bi-directional communications between the purchaser system 22 and the interconnection 8 via a landline connection (not shown) of the interconnection 8 such as a connector assembly conforming to an Ethernet™ communications connector standard or other suitable connector standards known in the art. The OP optical transceiver 22.16 enables the bi-directional light energy communications between the purchaser system 22 and (a.) a light sensing transceiver (not shown) of the interconnection 8; and/or (b.) the light sensor module of the energy 604 alternate tag 4A. The OP RFID transceiver 22.18 enables the both bi-directional communications between the purchaser system 22 and the RFID tag 4A and the provision of electrical energy to the RFID tag 4A via the RFID antenna 410.

The OP system memory 22.20 stores a plurality of software encoded information, instructions and records, to include an OP software operating system 22.22, an OP system software 22.24, an OP web server software 22.26, an OP web browser, an OP network address 22.30, a unique OP identifier RS.ID 22.32 and an OP database management system OP DBMS 22.34. The OP software operating system 22.22 enables the purchaser system 22 to perform basic and essential computational tasks, such as such as scheduling tasks, executing applications, and controlling peripherals. The OP system software 22.24 provides software-encoded instructions, data and information that enables the purchaser system 22 to perform in accordance with the aspects of the method of the present invention. The OP web server 22.26 enables the purchaser system 22 to generate and transmit web pages via the interconnection 8 to web browsers of systems and servers 8-12, 16-20, 24 & 26. The OP web browser 22.28 enables the purchaser system 22 to render received web pages. The OP network address 22.30 is a unique identifier that may be used to identify the purchaser system 22 as a sender or intended recipient of an electronic message. The POS.ID 22.32 uniquely identifies the purchaser system 22 to the network 2 and elements, systems and servers 8-12, 16-20, 24 & 26 thereof. The OP DBMS 22.34 stores one or more databases 22.36-22.40 that may each store electronic records, and/or representations of addresses messages and information.

Referring now generally to the Figures and particularly to FIG. 4G, FIG. 4G is a schematic diagram of the retail tag DB server 24. The retail DB server 24 includes a retail tag DB server (“RD”) central processing unit 24.02 (hereinafter, “RD CPU 24.02”) that is bi-directionally communicatively coupled to by an RD system communications bus 24.04 to an RD user input module 24.06, an RD display module 24.08, an RD wireless communications interface 24.10, an RD dock module 24.12, an RD landline communications bi-directional interface 24.14, an RD optical communications transceiver 24.16, an RD radio frequency identification device transceiver 24.18, and an RD system memory 24.20.

The RD user input module 24.06 may include a computer keyboard, a computer mouse and/or other human-to-computer input devices that enable a human user to input data, queries and commands to the tag DB server 24. The RD display module 24.08 is adapted to visually render data, images and other representations of other information as output by or by means of the retail DB server 24 for perception by a human operator. The RD wireless interface 24.10 enables the bi-directional communications between the retail DB server 24 and (a.) the interconnection 8; and (b.) the alternate tag 4A, wherein the RD wireless interface may be adapted to communicate in accordance with a BLUETOOTH™ communications standard or other suitable wireless communications standards or protocols. The RD dock module 24.12 is adapted to physically connect with the RFID tag hard dock interface 408 and/or the alt tag hard dock interface and enable bi-directional communications between the retail DB server 24 and the docked tag 4A & 6A. The RD landline interface 24.14 enables the bi-directional communications between the retail DB server 24 and the interconnection 8 via a landline connection (not shown) of the interconnection 8 such as a connector assembly conforming to an Ethernet™ communications connector standard or other suitable connector standards known in the art. The RD optical transceiver 24.16 enables the bi-directional light energy communications between the retail DB server 24 and (a.) a light sensing transceiver (not shown) of the interconnection 8; and/or (b.) the light sensor module of the energy 604 alternate tag 4A. The RD RFID transceiver 24.18 enables the both bi-directional communications between the retail DB server 24 and the RFID tag 4A and the provision of electrical energy to the RFID tag 4A via the RFID antenna 410.

The RD system memory 24.20 stores a plurality of software encoded information, instructions and records, to include an RD software operating system 24.22, an RD system software 24.24, an RD web server 24.26, and RD web browser 24.28, an RD network address 24.30, a unique tag DB server identifier TD.ID 12.32 and an RD database management system RD DBMS 24.34. The RD software operating system 24.22 enables the retail DB server 24 to perform basic and essential computational tasks, such as such as scheduling tasks, executing applications, and controlling peripherals. The RD system software 24.24 provides software-encoded instructions, data and information that enables the tag DB server to perform in accordance with the aspects of the method of the present invention. The RD web server 24.26 enables the retail DB server 24 to generate and transmit web pages via the interconnection 8 to web browsers of systems and servers 8-12, 16-22 & 26. The RD web browser 24.28 enables the retail DB server 24 to render received web pages. The RD network address 24.30 is a unique identifier that may be used to identify the retail DB server 24 as a sender or intended recipient of an electronic message. The RD identifier 24.32 uniquely identifies the retail DB server 24 to the network 2 and elements, systems and servers 8-12, 16-22 & 26 thereof. The RD DBMS 24.34 stores one or more databases 24.36-24.40 that may each store electronic records, and/or representations of addresses messages and information.

The retail server memory 24.20 may optionally store the first authorization code AUTH1 and/or the second authorization code AUTH2 and the retail DB server 24 may include the first authorization code AUTH1 and/or the second authorization code AUTH2 in query messages Q.MSG.01-Q.MSG.N. Alternatively or additionally, the first authorization code AUTH1 and/or the second authorization code AUTH2 may be accessed by the retail DB server 24 to verify the inclusion of the first authorization code AUTH1 and/or a second authorization code AUTH2 in query messages Q.MSG.01-Q.MSG.N received by the retail DB server 24.

Referring now generally to the Figures and particularly to FIG. 4H, FIG. 4H is a schematic diagram of the tag reader server 26. It is understood that a primary function of the tag reader server 26 (hereinafter, “reader sever 26”) is to enable communications to and from one or more tag readers 14A-14N and to and from one or more elements, systems or servers 8-24 of the network 2.

The reader server 26 includes a tag reader (“TRS”) central processing unit 26.02 (hereinafter, “TRS CPU 26.02”) that is bi-directionally communicatively coupled to by a TRS system communications bus 26.04 to a TRS user input module 26.06, a TRS display module 26.08, a TRS wireless communications interface 26.10, a TRS dock module 26.12, a TRS landline communications bi-directional interface 26.14, a TRS optical communications transceiver 26.16, a TRS radio frequency identification device transceiver 26.18, and a TRS system memory 26.20.

The TRS user input module 26.06 may include a computer keyboard, a computer mouse and/or other human-to-computer input devices that enable a human user to input data, queries and commands to the tag DB server 26. The TRS display module 26.08 is adapted to visually render data, images and other representations of other information as output by or by means of the retail DB server 24 for perception by a human operator. The TRS wireless interface 26.10 enables the bi-directional communications between the retail DB server 24 and (a.) the interconnection 8; and (b.) the alternate tag 4A, wherein the TRS wireless interface may be adapted to communicate in accordance with a BLUETOOTH™ communications standard or other suitable wireless communications standards or protocols. The TRS dock module 26.12 is adapted to physically connect with the RFID tag hard dock interface 408 and/or the alt tag hard dock interface and enable bi-directional communications between the retail DB server 24 and the docked tag 4A & 6A. The TRS landline interface 26.014 enables the bi-directional communications between the retail DB server 24 and the interconnection 8 via a landline connection (not shown) of the interconnection 8 such as a connector assembly conforming to an Ethernet™ communications connector standard or other suitable connector standards known in the art. The TRS optical transceiver 26.16 enables the bi-directional light energy communications between the retail DB server 24 and (a.) a light sensing transceiver (not shown) of the interconnection 8; and/or (b.) the light sensor module of the energy 604 alternate tag 4A. The TRS RFID transceiver 26.18 enables the both bi-directional communications between the retail DB server 24 and the RFID tag 4A and the provision of electrical energy to the RFID tag 4A via the RFID antenna 410.

The TRS system memory 26.20 stores a plurality of software encoded information, instructions and records, to include a TRS software operating system 26.22, a TRS system software 26.24, a TRS web server 26.26, and TRS web browser 26.28, a TRS network address 26.30, a unique tag DB server identifier TD.ID 12.32 and a TRS database management system TRS DBMS 26.34. The TRS software operating system 26.22 enables the retail DB server 24 to perform basic and essential computational tasks, such as such as scheduling tasks, executing applications, and controlling peripherals. The TRS system software 26.24 provides software-encoded instructions, data and information that enables the tag DB server to perform in accordance with the aspects of the method of the present invention. The TRS web server 26.26 enables the retail DB server 24 to generate and transmit web pages via the interconnection 8 to web browsers of systems and servers 8-12, 16-24. The TRS web browser 26.28 enables the retail DB server 24 to render received web pages. The TRS network address 26.30 is a unique identifier that may be used to identify the retail DB server 24 as a sender or intended recipient of an electronic message. The TRS identifier 26.32 uniquely identifies the retail DB server 24 to the network 2 and elements, systems and servers 8-12, 16-24 thereof. The TRS DBMS 26.34 stores one or more databases 26.36-26.40 that may each store electronic records, and/or representations of addresses messages and information.

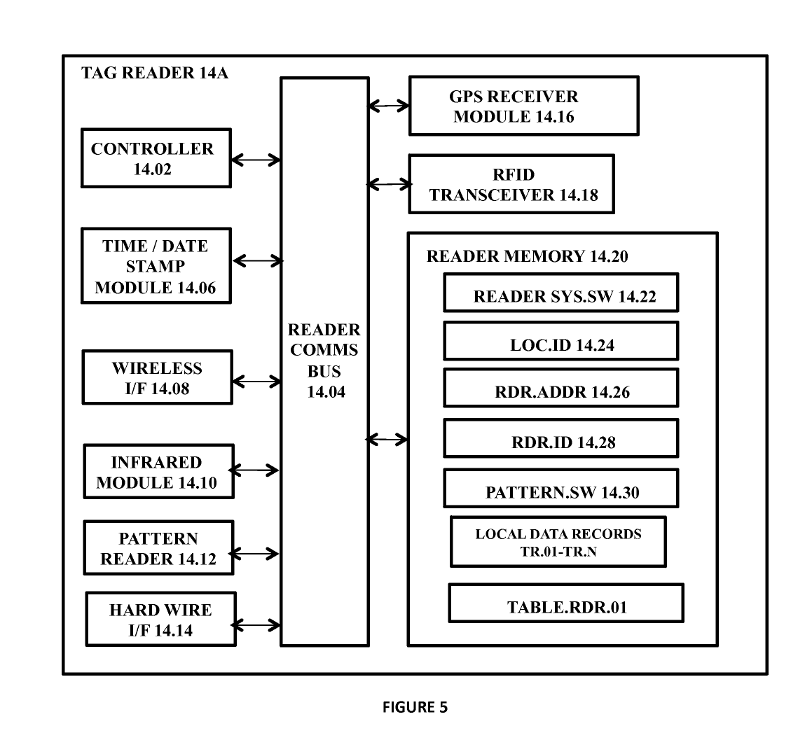

Referring now generally to the Figures and particularly to FIG. 5, FIG. 5 is a schematic diagram of an exemplary first tag reader 14A. It is understood that each of the plurality of tag readers 14B-14N may include, one, some or all of the elements 14.02-14.30 & TR.01-TR.N and the aspects of the first tag reader 14A as disclosed.

A controller 14.02 is communicatively coupled by a reader communications bus 14.04 to a time date stamp generation module 14.06, a wireless communications interface module 14.08, an infrared light energy communications module 14.10, a bar code/QR pattern reader 14.12, a hardwire/landline communications interface module 14.14, a global positioning system receiver 14.16, an RFID transceiver 14.18 and a reader memory 14.20. The reader memory 14.20 stores a plurality of software 14.22-14.30 & TR.0-TR.N, including a reader system software 14.22, a location identifier LOC.ID 14.24, a reader network address RDR.ADDR 14.26, a reader identifier RDR.ID14.28, a pattern interpretation software PATTERN.SW 14.30 and a plurality of locally stored data records TR.01-TR.N.

The controller 14.02 may be programmable, configurable, reprogrammable and/or reconfigurable to comprise instructions that enable the first RFID tag 4A to operate in accordance with one, more than one, or all aspects the invented method.

The time date stamp generation module 14.06 may comprise a real time clock circuit and is adapted to generate time and date data that the first tag reader 14A writes into local records TR.1-TR.N and/or transmits to one or more readers 14A-14N and/or systems and/or servers 10-26 of the network 2.

The wireless communications interface module 14.08 bi-directionally communicatively couples the first tag reader 14A to the network 2. The infrared light energy communications module 14.10 enables the first tag reader 14A to send and/or receive infrared and light spectrum based messages. The bar code/QR pattern reader 14.12 enables the first tag reader 14A to detect visual, light-detectable, imprinted, printed and/or stamped image data, such as bar code patterns and QR patterns. The hardwire/landline communications interface module 14.14 enables the first tag reader 14A to mechanically couple with and bi-directionally communicatively couple with the network 2 and may comprise a connector assembly, such as a connector assembly conforming to an Ethernet™ communications connector standard or other suitable connector standards known in the art.

The reader global positioning system receiver 14.16 (hereinafter, “reader GPS receiver 14.16”) is adapted to receive geolocational signals from the Global Positioning System (hereinafter, “GPS”) space-based satellite navigation system that is maintained by the government of the United States and provides location and time information. The reader GPS receiver 14.16 is further adapted to derive and generate geolocational GPS data from signals received from the GPS.

The RFID transceiver 14.18 enables the first tag reader 14A to send and receive electronic messages via wireless radio frequency communications to the RFID tag devices 4A-4N and the alternate tag devices 6A-6N, as well as transmit electrical energy to the RFID antennae 412 of the RFID tag devices 4A-4N.

The reader system software 14.22 comprises instructions that enable the first reader 14A to operate in accordance with one, more than one, or all aspects the invented method. The location identifier LOC.ID 14.24 is a datum that uniquely identifies the location of the first reader 14A to at least the tag DB server 12 and preferably to the retail DB server 24. The reader network address RDR.ADDR 14.26 is a network communications address that may be used by the first reader 14A to send electronic messages and initiate messages, and correspondingly by the network 2 and devices 14A-14N, systems, servers and elements 10-26 thereof to address electronic messages to and initiate communications sessions with the first reader 14A. The reader identifier RDR.ID 14.28 is an identification datum that uniquely identifies the first reader 14A to at least the tag DB server 12 and preferably to the retail DB server 24. The pattern interpretation software PATTERN.SW 14.30 is adapted, and enables the first reader 14A to interpret patterns detected by the bar code/QR pattern reader 14.12 and derives information from data generated by the bar code/QR pattern reader 14.12.

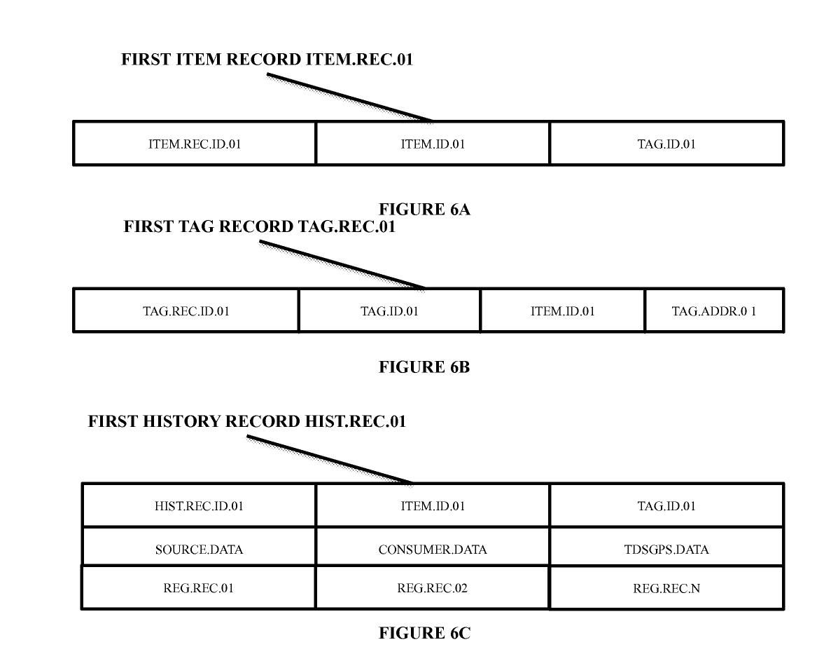

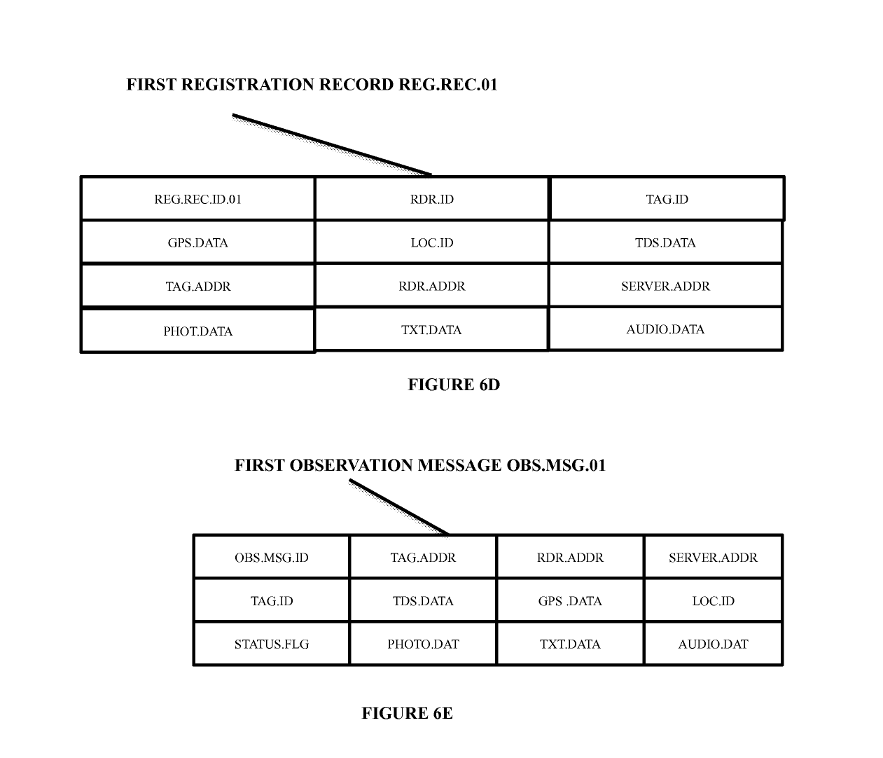

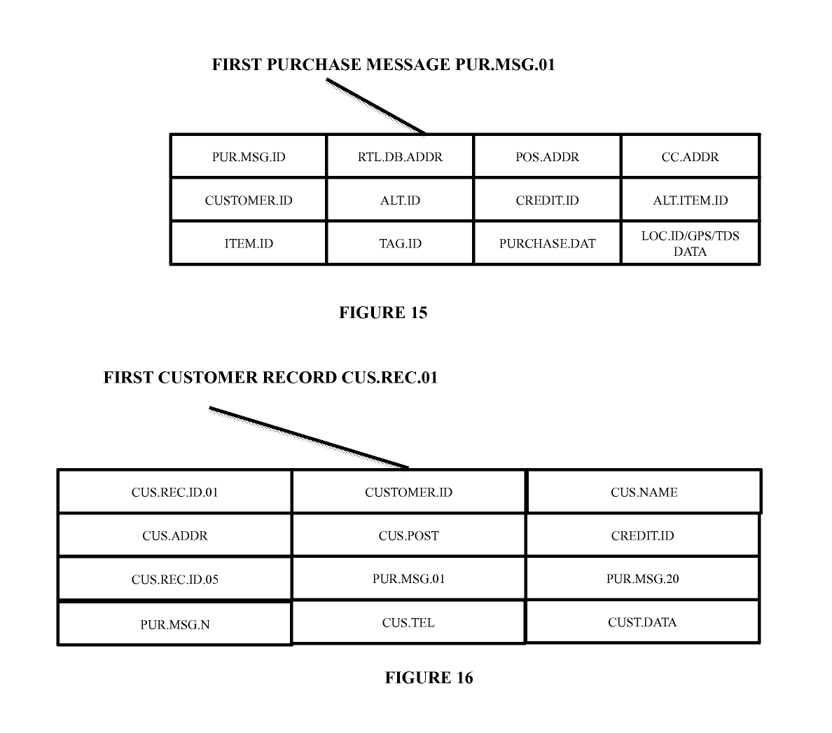

Referring now generally to the Figures and particularly to FIGS. 1, 2A, 2B, 4B, 4G, 6A through 6E, 15A and 15B, FIGS. 6A through 6E, 15A and 15B are block diagrams of the information content of a exemplary records and messages plurality of electronic records, record types, messages and message types that may be stored in one or more elements, systems and servers 10-26 and readers 14A-14N of the network 2. In particular, it is understood that singular or pluralities of electronic records, record types, messages and message types of FIGS. 6A through 6E, 15A and 15B may be stored as local records TR.01-TR.N in one or more RFID tags 4A-4N, alternate tags 6A-6N, and/or readers 14A-14N.

Referring now to FIG. 6A is a block diagram of an exemplary first item record ITEM.REC.01 that associates the first RFID tag identifier TAG.ID.01 with a first item identifier ITEM.ID.01. The first item record ITEM.REC.ID.01 may additionally include an optional first item record identifier ITEM.REC.ID.01 that uniquely identifies the comprising first item record ITEM.REC.01 to at least the tag DB server 12. A plurality of item records ITEM.REC.01-ITEM.REC.N each uniquely associate a unique tag identifier TAG.ID.01-TAG.ID.N with a particular tangible item identifier ITEM.ID.01-ITEM.ID.N and thereby associate each tag unique identifier TAG.ID.01-TAG.ID.N with a particular tangible item ITEM.01-ITEM.N. The plurality of item records ITEM.REC.01-ITEM.REC.N may individually and selectively be stored throughout the network 2 and optionally as local records TR.01-TR.N.

Referring now to FIG. 6B is a block diagram of an exemplary first tag record TAG.REC.01 that also associates the first RFID tag identifier TAG.ID.01 with the first item identifier ITEM.ID.01. The first tag record TAG.REC.01 preferably further comprises a network address TAG.ADDR.01 to which messages referencing or related to the first tag 4A or an associated item ITEM.01-ITEM.N may be sent.

The first tag record TAG.REC.ID.01 may additionally include an optional first tag record identifier TAG.REC.ID.01 that uniquely identifies the comprising first tag record TAG.REC.01 to at least the tag DB server 12. A plurality of tag records TAG.REC.01-TAG.REC.N each uniquely associate a unique tag identifier TAG.ID.01-TAG.ID.N with a particular tangible item identifier ITEM.ID.01-ITEM.ID.N and thereby associate each tag unique identifier TAG.ID.01-TAG.ID.N with a particular tangible item ITEM.01-ITEM.N. The plurality of tag records TAG.REC.01-TAG.REC.N may individually and selectively be stored throughout the network 2 and optionally as local records TR.01-TR.N.

FIG. 6C is a block diagram of an exemplary first history record HIST.REC.01 that maintains information associated with the exemplary tag identifier TAG.ID.01, to include a source information SOURCE.DATA, a consumer information CONSUMER.DATA, a time, date and geolocation informational TDSGPS.DATA related to the origin or first shipment of the associated tag 4A-4N & 6A-6N or item ITEM.01-ITEM.N, and a plurality of registration records REG.REC.01-REG.REC.N received from tag readers 14A-14N and other systems and servers 10-26 of the network 2. It is understood that additional history records HIST.REC.02-HIST.REC.N are preferably each adapted and formed to maintain separate plurality of registration records REG.REC.01-REG.REC.N received from tag readers 14A-14N and other systems and servers 10-26 of the network 2, wherein each separate plurality of registration records REG.REC.01-REG.REC.N of an individual history records HIST.REC.02-HIST.REC.N is associated with a same tag identifier TAG.ID.01-TAG.1D.N.

Referring now generally to the Figures and particularly to FIG. 6D, FIG. 6D is an exemplary first registration record REG.REC.01 as maintained within the first exemplary history record HIST.REC.01 by the tag DB server 12. The first registration record REG.REC.01 includes (a.) a first registration record identifier REG.REC.ID.01, (b.) a reader identifier RDR.ID of the tag reader 14A-14N that provided at least some of the information contained within the comprising first registration record REG.REC.01, (c.) a tag identifier TAG.ID of a tag 4A-4N & 6A-6N of a tag associated with at least some of the information contained within the comprising first registration record REG.REC.01, (d.) a geolocational datum GPS.DATA provided by the tag reader 14A-14N identified by the reader identifier RDR.ID, or the tag 4A-4N & 6A-6N identified by the tag identifier TAG.ID, or the reader server 26, (e.) a location identifier LOC.ID of the tag reader 14A-14N identified by the reader identifier RDR.ID or the reader server 26; (f.) a time date stamp datum TDS.DATA may indicate a time and date for association with the first registration record REG.REC.01; (g.) a tag network address TAG.ADDR associated with the tag 4A-4N & 6A-6N identified by the tag identifier TAG.ID, (h.) a tag reader network address RDR.ADDR associated with the reader 14A-14N identified by the tag reader identifier and/or the reader server 26; (i.) a reader server network address SERVER.ADDR associated with the reader server 26; and (j.) additional photographic or video data PHOT.DATA, textual data TXT.DATA and/or audio data AUDIO.DATA.

Referring now generally to the Figures and particularly to FIG. 6E, FIG. 6E is an exemplary first observation message OBS.MSG.01 as transmitted by a tag reader 14A-14N. The first exemplary observation message OBS.MSG.01 is addressed to a tag network address TAG.ADDR.01-TAG.ADDR.N of a tag 4A-4N & 6A-6N from which certain related information of the first observation message OBS.MSG.01 was read or received, such as TAG.ID, TAG.ADDR, TDS.DATA, GPS.DATA, PHOTO.DATA, TXT.DATA and/or AUDIO.DATA. Additionally or alternatively, the reader 14A-14N identified by the reader identifier RDR.ID the server 26, or other elements 10-24 of the network, may provide certain data comprised within the first observation message OBS.MSG.01, such as TAG.ID, TAG.ADDR, TDS.DATA, GPS.DATA, PHOTO.DATA, TXT.DATA and/or AUDIO.DATA. A status flag STATUS.FLG may also be configured, encoded and/or applied to indicate a status of the tag identified by the tag identifier TAG.ID, for example as being received, or being released for further transit, or being held at the time of the generation of the first observation message OBS.MSG.01.

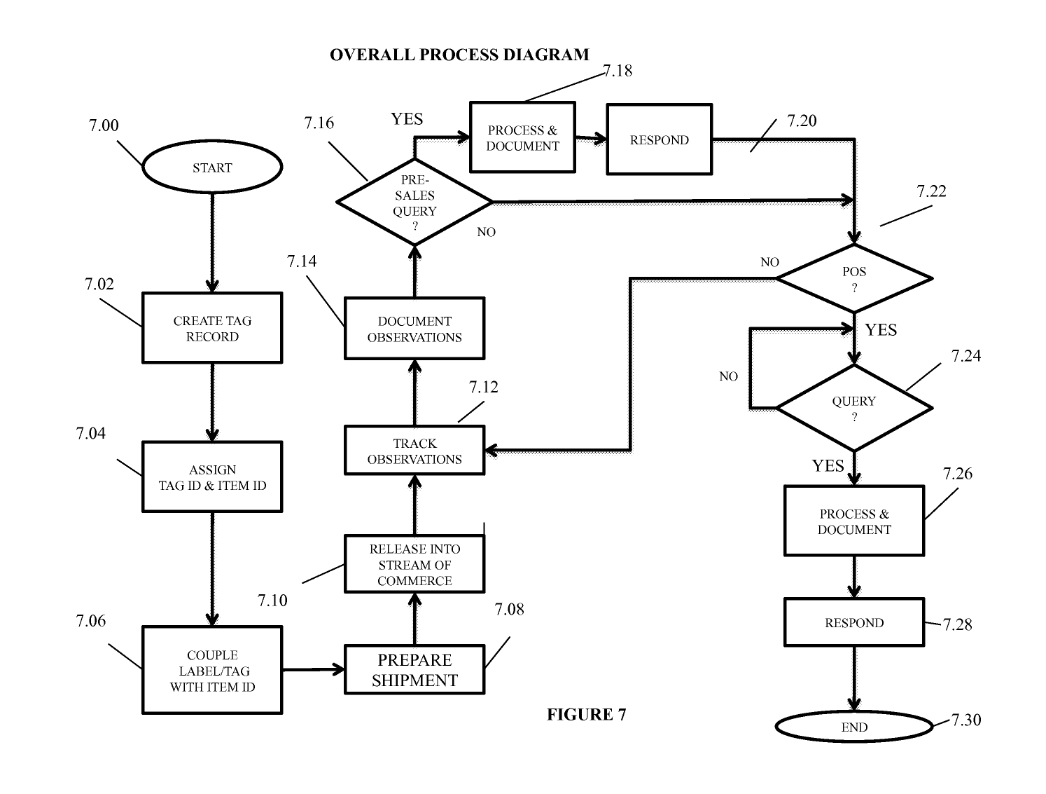

Referring now generally to the Figures and particularly to FIG. 7, FIG. 7 is a process chart of the invented method. An exemplary tag record TAG.REC is created at the origin system in step 7.02 and a tag identifier TAG.ID is (a.) read from an exemplary individual tag 4A-4N or 6A-6N in step 7.04, (b.) generated by the origin system 10, or (c.) received by the origin system 10 from the tag DB server 12, wherein the a tag identifier TAG.ID is written into the tag record in addition to an item identifier ITEM.ID. The exemplary tag 4A-4N or 6A-6N is then attached with the basic label 300 to, or directly to a container 310, 318 & 324. The exemplary item ITEM.01-ITEM.N associated with the item identifier ITEM.ID is then prepared for shipment in step 7.10 and is released into the stream of commerce in step 7.12. Reports and queries referencing the instant tag identifier TAG.ID or item identifier ITEM.ID are then tracked in the loop of step 7.12 through 7.22 wherein information received in queries or observation messages OBS.MSG.01-OBS.MSG.N is documents and collated in association the instant tag identifier TAG.ID and/or item identifier ITEM.ID in a history record HIST.REC. In step 7.14 observations messages OBS.MSG.01-OBS.MSG.N may be received and documented in whole or in part in an exemplary history record HIST.REC. In steps 7.16 through 7.20 queries referencing the instant tag identifier TAG.ID and/or item identifier ITEM.ID issued prior to a retail or final sale of the instant item ITEM.01-ITEM.N are detected, documented and responded to by the tag DB server 12, retail DB server 24 and/or other systems or servers 16-22 & 26 individually, in combination or in concert.

In step 7.22 the tag DB server 12 and/or the retail DB server 24 determine whether the POS 20 has communicated that the item ITEM.01-ITEM.N associated with either the instant tag identifier TAG.ID and/or item identifier ITEM.ID has been purchased. When the tag DB server 12 and/or the retail DB server 24 detects receipt of an after-sales query that references the instant tag identifier TAG.ID and/or item identifier ITEM.ID, the recipient DB server 12 or 24 processes and documents the received after-sales query and in step 7.26, optionally by updated the associated history record HIST.REC in step 7.26 and responds to the after-sales query of step 7.24 in step 7.28. It is understood the query loop of step 7.24 may be discontinued, or timed out after certain time duration.

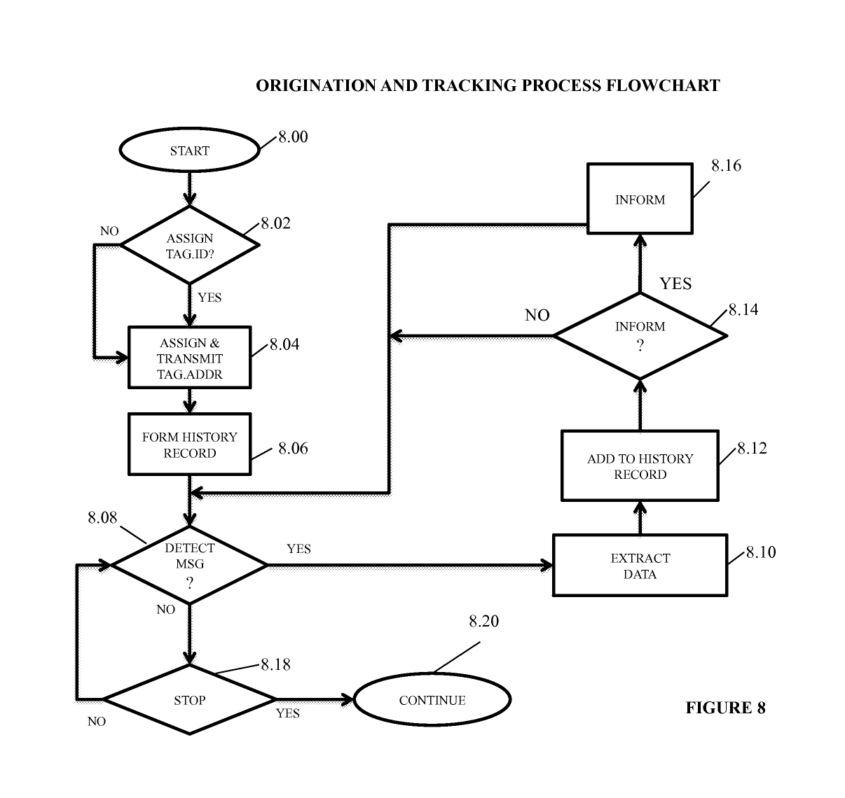

Referring now generally to the Figures and particularly to FIG. 8, FIG. 8 is a flow chart of the operation of the tag DB server 12 in accordance with the invented method. In step 8.02 a tag identifier is generated for tag devices 4A-4N & 6A-6N that lack native identifiers TAG.ID, and in step 8.04 a tag network address TAG.ADDR and optionally a tag identifier TAG.ID is transmitted to the origin system 10 for recordation into a tag identifier record TAG.REC. The tag DB server 12 next generates a history record HIST.REC that references the tag address TAG.ADDR of step 8.04 and preferably the identifier TAG.ID of step 8.02. The tag DB server 12 processes received information sent upon detections of the identifier TAG.ID associated with the tag address TAG.ADDR of step 8.04 and updates the history record HIST.REC of step 8.06 with preferably at least some of the observation messages OBS.MSG-01-OBS.MSG.N and other electronic messages detected in step 8.08.

The tag DB server 12 extract data from messages detected in step 8.08 and updates each history record HIST.REC.01-HIST.REC.N associated with each detected observations message OBS.MSG.01-OBS.MSG.N detected in step 8.08. The DB server 12 determines in step 8.14 whether to inform one or more other systems or servers 10 and 14-26 and/or tag readers 14A-14N of any information extracted in step 8.10, and then formats and sends informational electronic messages in step 8.16.

The tag DB server 12 determines in step 8.18 whether to exit the loop of steps 8.08 through 8.16 in reference to the tag address TAG.ADDR of step 8.04 and to proceed onto other computational tasks in step 8.20.

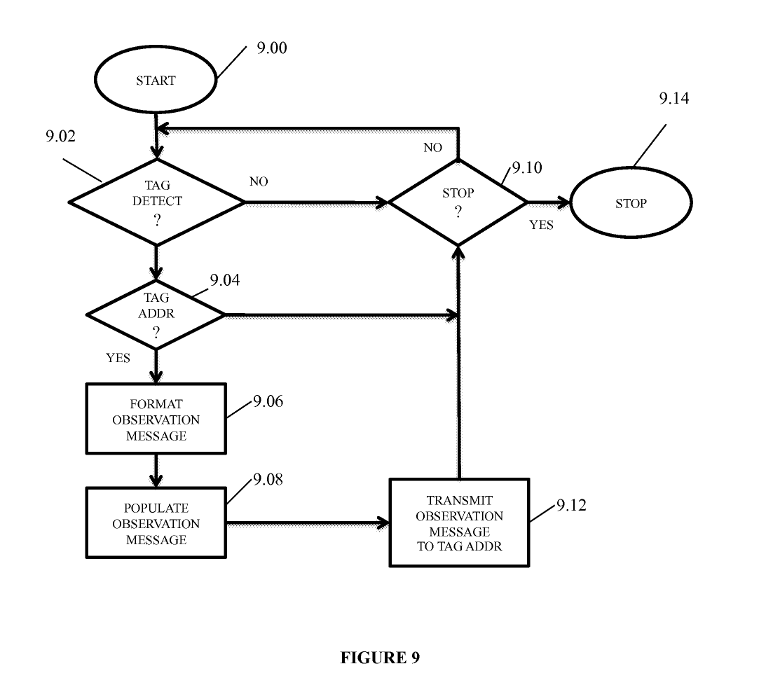

Referring now generally to the Figures and particularly to FIG. 9, FIG. 9 is a flow chart of the operation of the exemplary first tag reader 14A in accordance with the invented method. When the first tag reader 14A detects a tag 4A-4N or 6A-6N in step 9.02 and also relates a tag identifier TAG.ID to a tag network address TAG.ADDR, the first tag reader 14A formats an observation message OBS.MSG in step 9.06 and populates this observation message OBS.MSG in step 9.08 with information generated by the first tag reader 14A and/or read from the tag 4A-4N or 6A-6N detected in step 9.02. The written into the instant observation message OBS.MSG might include information indicated in FIG. 6E and that night alternatively or additionally provided by the reader server 26 and/or information provided to the reader server 26 or the first tag reader 14A by other tag readers 14B-14N and/or systems and servers 10-24 of the network 2.

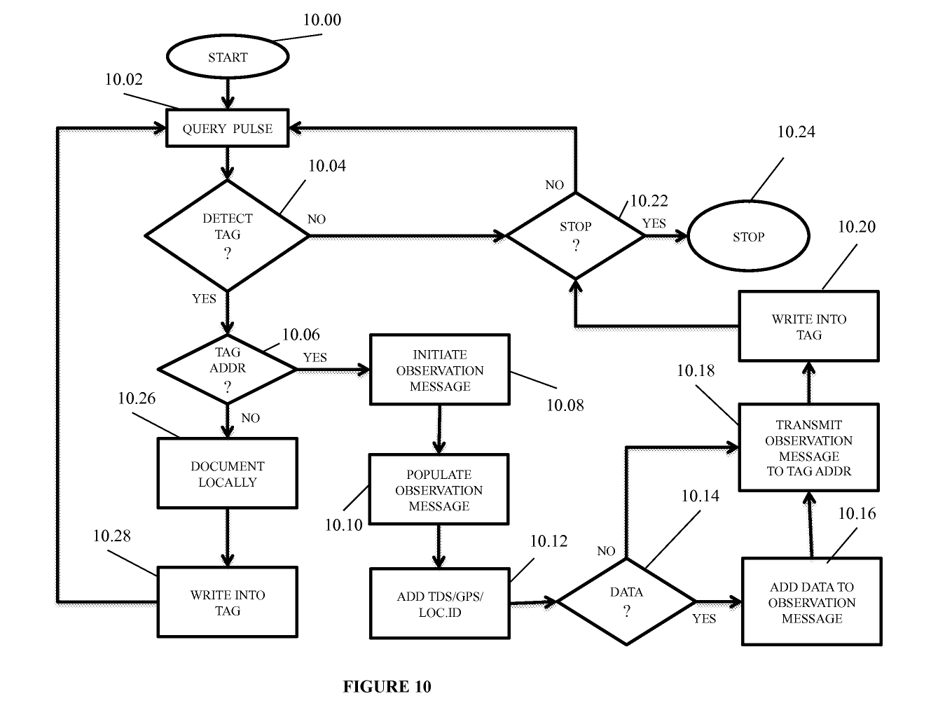

Referring now generally to the Figures and particularly to FIG. 10, FIG. 10 is a flow chart of the operation of the exemplary first tag reader 14A in accordance with the invented method. When the first tag reader 14A detects an RFID tag 4A-4N by first issuing an RFID query radio-wave signal pulse in step 10.02 and receiving an RFID responding message in step 10.04, the first tag reader 14A proceeds onto to determine if a network tag address TAG.ADDR is associated with a detected RFID tag 4A-4N in step 10.06. It is understood that the first tag reader 14A may be providing electrical energy to the detected RFID tag 4A-4N via the RFID transceiver 14.18 and the RFID antenna 410.

When the first tag reader 14A receives a tag address TAG.ADDR from the detected RFID tag 4A-4N, or alternatively receives a tag address TAG.ADDR associated with the detected RFID tag 4A-4N from the reader server 26 or via the network 2, the first tag reader 14A proceeds from step 10.06 to step 10.08 to initiate an observation message OBS.MSG and to then populate the observation message OBS.MSG in step 10.10. GPS data and/or a time-date stamp generated by a first reader 14A, as generated and transmitted by the detected RFID tag 4A-4N, and/or provided by the reader server 26 or via the network 2 may be added to the instant observation message OBS.MSG in step 10.12. The first tag reader 14A determines in step 10.14 whether additional data, e.g., STATUS.FLG, PHOT.DATA, TXT.DAT, and/or AUDIO.DATA shall be added to the observation message OBS.MSG and proceeds to add such additional data to the observation message OBS.MSG in step 10.16. It is understood the additional data added to the OBS.MSG in step 10.16 may be sourced from a tag 4A-4N & 6A-6N, the reader server 26 and/or received via or from the network 2.

The first tag reader 14A the transmits the observation message OBS.MSG in step 10.18 as generated and populated in steps 10.08 through 10.16 to the server reader 26, the tag DB server, the retail DB server 24 and/or other readers 14B-14N or system 16-22 of the network 2. In optional step 10.20 the first reader 14A may fully or partially writes some or all of the information of the observation message OBS.MSG into the RFID tag 4A-4N detected in step 10.04. It is understood that steps 10.02 through 10.20 may be performed by the first tag reader 14A in concert, cooperation or collaboration with the reader server 26 or other server or system 10-24 of the network 2.

The first tag reader 14A determines in step 10.22 whether to proceed on to step 10.02 issue another RFID query pulse or to proceed on to other computational operations of step 10.24. Referring now back to step 10.06, when no associated tag network address TAG.ADDR is received by the first tag reader 14A in step 10.06, the first tag reader 14A proceeds on to step 10.26 and stores the information specified in steps 10.08 through 10.18 into a local record TR.01-TR.N and optionally writes this local record TR.01-TR.N into the RFID tag 4A-4N detected in step 10.04.

It is understood that the method of FIG. 10 may also be applied to an alternate tag device 6A-6N wherein the first tag reader 14A is not required to provide electrical energy to detected alternate tag device 6A-6N.

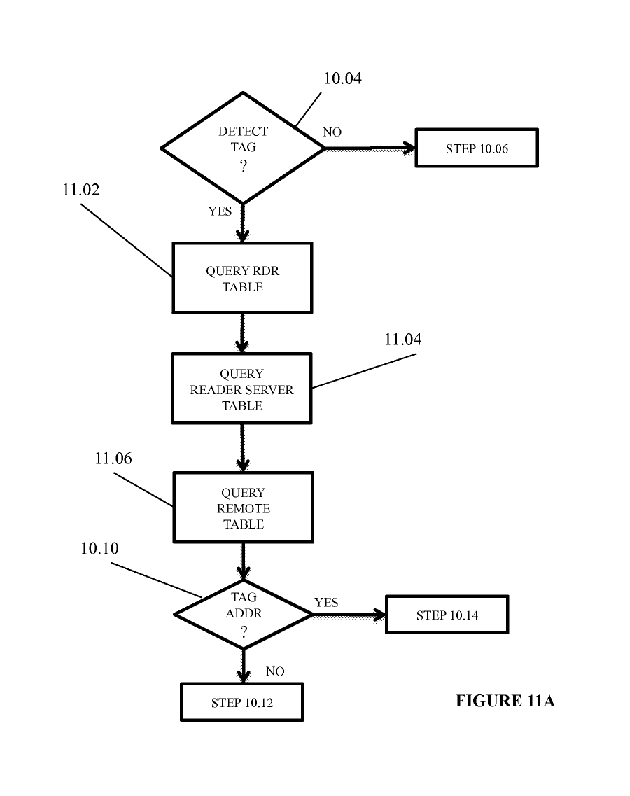

Referring now generally to the Figures and particularly to FIG. 11A, FIG. 11A is a flowchart of alternate, optional and additional aspects of the invented method as performed by a tag reader 14A-14N. Addressing now the optional actions of the first tag reader 14A as being illustrative of alternate preferred embodiments of the method of the present invention that may be performed by one on more other tag readers 14A-14N, when the first reader 14A detects a tag identifier TAG.ID in step 10.04 as presented by a bar code or a QR code on the basic label 300, or digitally stored within a tag 4A-4N & 6A-6N, the first reader 14A may in step 11.02 consult a first reader look up table T.RDR.01 that is stored in the reader memory 14.20 of the first reader 14A to see if a particular tag address TAG.ADDR.01-TAG.ADDR.N is associated with the tag identifier TAG.ID.01-TAG.ID.N detected in step 10.04. The first reader 14A may alternately or additionally in step 11.04 consult a reader server look up table T.SVRDR that is stored in the server reader memory 26.20 of the reader server 26 to determine if a particular tag address TAG.ADDR.01-TAG.ADDR.N is associated with the tag identifier TAG.ID.01-TAG.ID.N detected in step 10.04. The first reader 14A may still alternately or additionally in step 11.06 consult a remote server look up table T.REM that may be stored in a remote tag reader 14B-14N, system or server 10-26 to determine if a particular tag address TAG.ADDR.01-TAG.ADDR.N is associated with the tag identifier TAG.ID.01-TAG.ID.N detected in step 10.04.

When a tag address TAG.ADDR.01-TAG.ADDR.N is determined in step 10.10 to have been detected or received by the first tag reader 14A (a.) by reading of the bar code 302; (b.) by reading of the QR code 304; (c.) by radio wave or optical wave energy transmission from a tag 4A-4N & 6A-6N; (d.) by accessing a local tag address lookup table T.RDR.01-T.RDR.N; (e.) by accessing a reader server look up table T.SVRDR; and/or (e.) by accessing a remote look up table T.REM, the first tag reader 14A proceeds from step 10.01 to step 10.14.

When a tag address TAG.ADDR.01-TAG.ADDR.N is net detected in step 10.10 by the first tag reader 14A, the first tag reader 14A proceeds from step 10.01 to step 10.12.

Referring now generally to the Figures and particularly to FIG. 11B, FIG. 11B is a block diagram of a tag address look up table 1100 that may be stored (a.) in a tag reader 14A-14N as a reader look up table T.RDR.01-RDR.N, (b.) in the reader server 26 as a reader server look up table T.SVRDR; and/or (c.) in a system or server 10-24 as a remote look up table T.REM. The tag address look up table 1100 pairs each tag identifier TAG.ID.01-TAG.ID.N with a single tag network address TAG.ADDR.01-TAG.ADDR.N. It is understood that more than one tag identifier TAG.ID may optionally or alternatively paired with a same tag network address, e.g., the first tag identifier TAG.ID.01 and the fourth tag identifier TAG.ID.04 are paired with a same first tag network address TAG.ADDR.01.

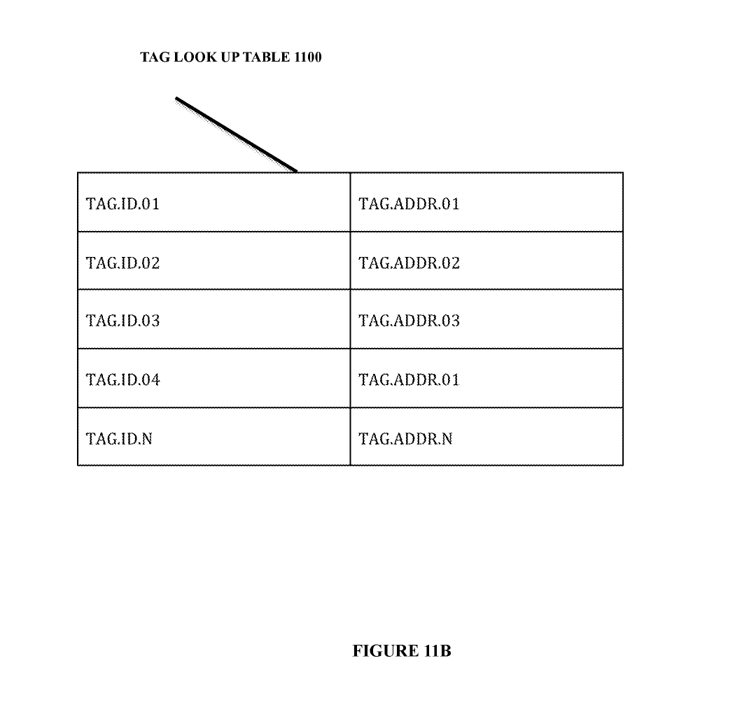

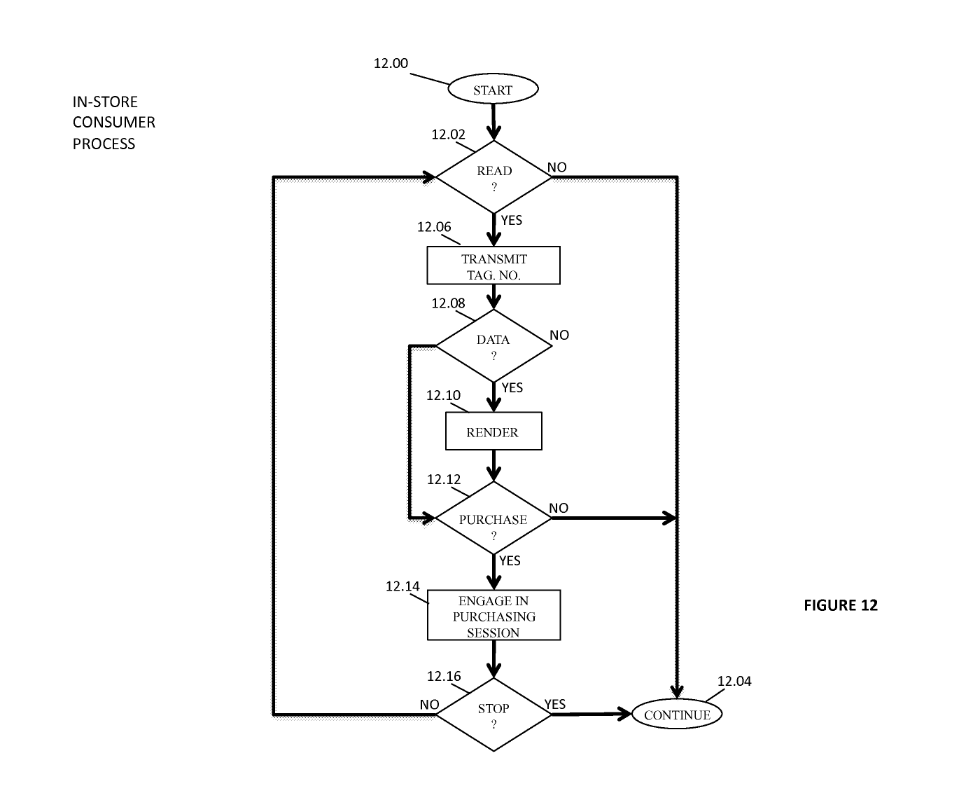

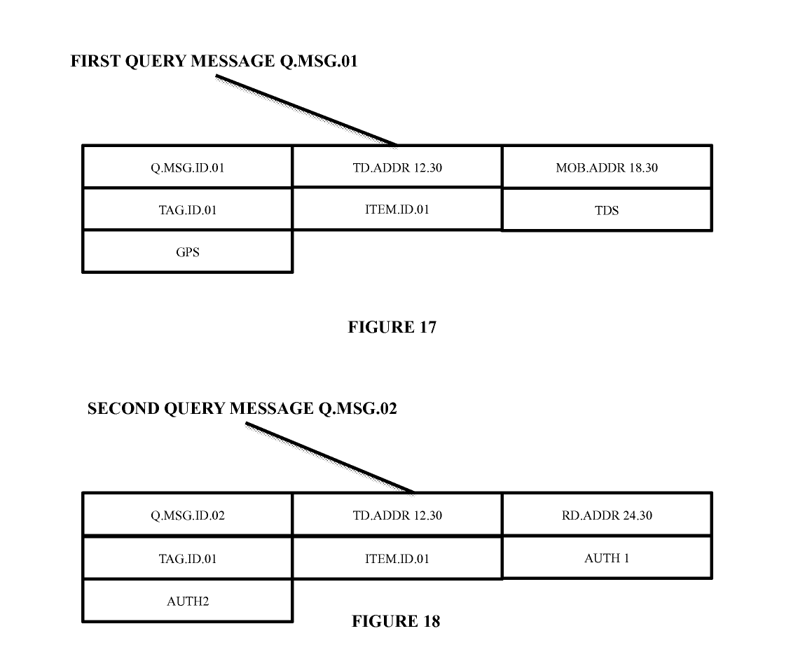

Referring now generally to the Figures and particularly to FIG. 12, FIG. 12 is a software flowchart of the mobile device 18 interacting with a customer and the network 2, whereby the mobile device 18 may receive information stored in reference to a particular tag identifier TAG.ID.01-TAG.N. It is understood that a customer or other requester may selectively be provided some information related to a tag identifier TAG.ID.01-TAG.N on the basis of authorization levels. For example, source information SOURCE.DATA of a history record HIST.REC.01-HIST.REC.N and/or consumer data CONSUMER.DATA may be made available to a requestor on the basis of merely providing an associated tag identifier TAG.ID.01-TAG.ID.N in a request for information, whereas access to registration records REG.REC.01-REG.REC.N of a same history record HIST.REC.01-HIST.REC might only be made accessible by a system 10, 16, 20 or server 12 & 24 when authentication and authorization credentials are presented with a request to access the history records HIST.REC.01-HIST.REC associated with a tag identifier TAG.ID.01-TAG.ID.N. This inventive optional aspect of access distinctions of the invented method is discussed in greater specificity particularly in reference to FIGS. 17 through 21 of the present disclosure.

The customer may acquire a tag identifier TAG.ID.01-TAG.ID.N by applying the mobile device 18 before purchase of an item ITEM.01-ITEM.N IN STEP 12.02 to attempt to acquire a tag identifier by (a.) radio wave or light energy wave communication with a tag 4A-4N & 6A-6N to receive a tag identifier TAG.ID.01-TAG.ID.N; (b.) read a tag identifier TAG.ID.01-TAG.ID.N from the bar code 302; and/or (c.) read a tag identifier TAG.ID.01-TAG.ID.N from the QR code.

When the mobile device 18 does not detect a tag identifier TAG.ID.01-TAG.N in step 12.02, the mobile device 18 proceeds on to step 12.04 and to perform alternate computational operations. In the alternative, if the mobile device 18 detects a tag identifier TAG.ID.01-TAG.N in step 12.02, the mobile device 18 transmits the instant tag identifier TAG.ID.01-TAG.N in a query message to the retail system 16, the POS 20, the retail DB server 24 and/or the tag DB server 12 with a request for information associated with the instant tag identifier TAG.ID.01-TAG.N. When receipt of information associated with the instant tag identifier TAG.ID.01-TAG.N of step 12.02 is received from the network 2 by the mobile device 18 in step 12.08, the mobile device 18 renders the received information in step 12.10. The customer may optionally next decide to initiate a purchase process in step 12.12 in communication with the POS 20 or certain other systems 16 or servers 24, and in step 12.14 engage in a purchasing session wherein an item ITEM.01-ITEM.N associated with the tag identifier TAG.ID.01-TAG.ID.N transmitted in step 12.06. The mobile device 18 may next, as directed by the customer pass through step 12.16 and return to step 12.02 or alternatively proceed from step 12.26 to step 12.04.

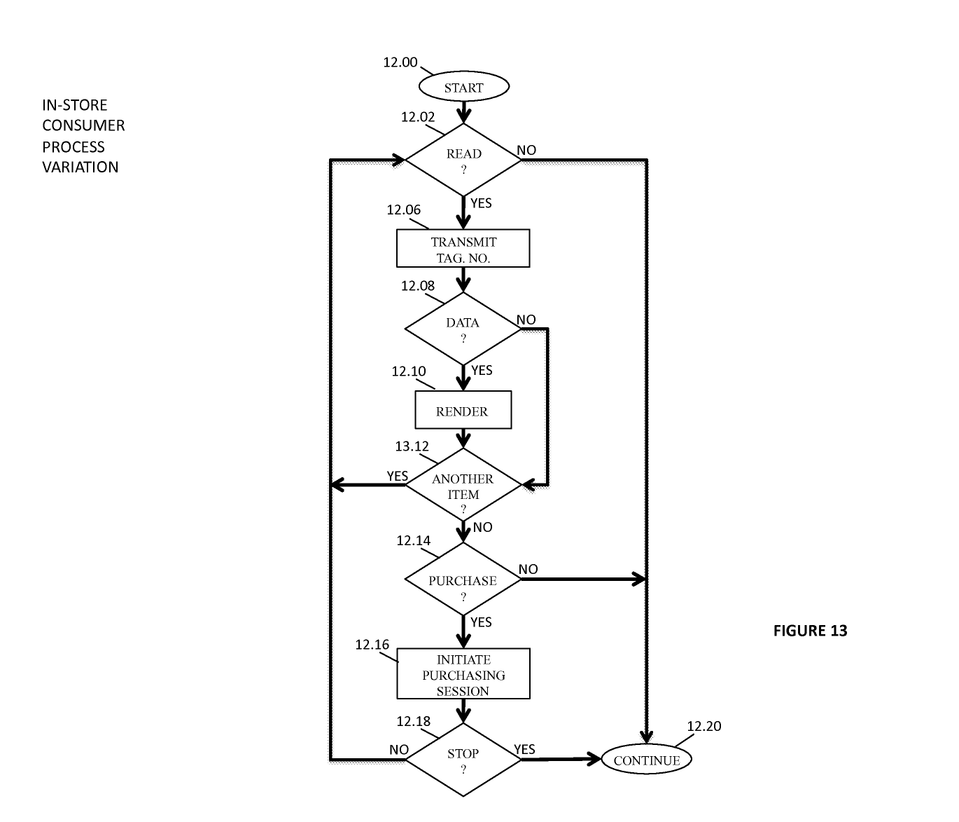

Referring now generally to the Figures and particularly to FIG. 13, FIG. 13 is a software flowchart of the mobile device 18 interacting with a customer and the network 2 in alternate process, whereby the customer may direct the mobile device in step 13.02 to examine a tag 4A-4N & 6A-6N or the basic label 300 of another item ITEM.01-ITEM.N at step 13.02 and before engaging in a purchasing session of step 12.14.

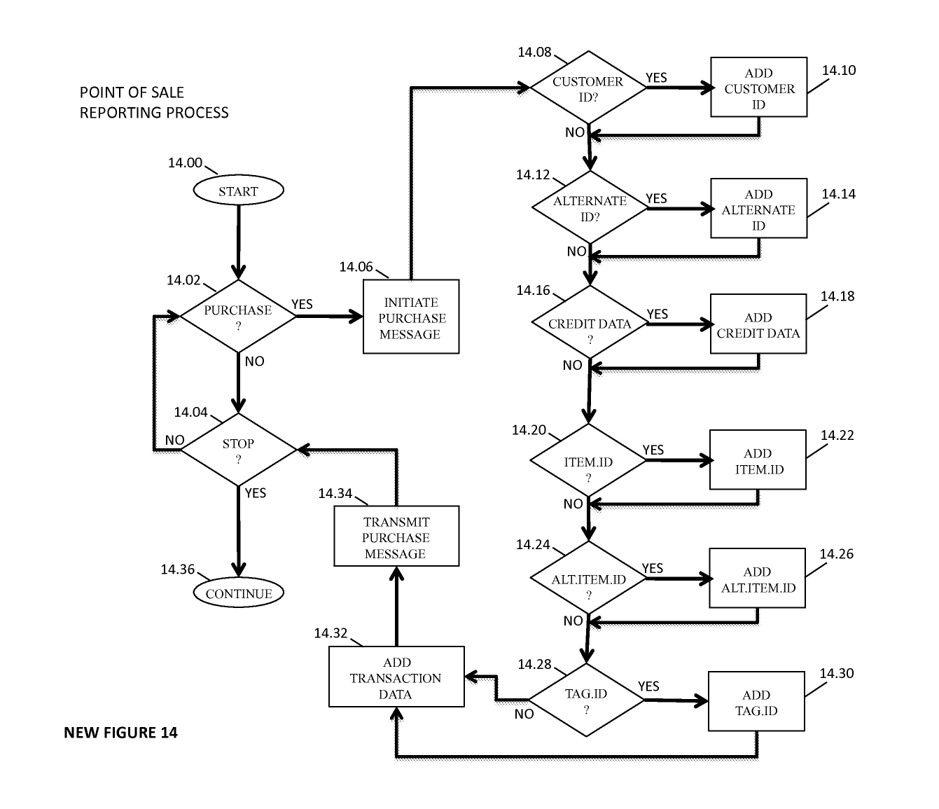

Referring now generally to the Figures and particularly to FIG. 14, FIG. 14 is a software flowchart of a process of the POS in engaging in a purchasing session that may comprise acquiring information from a tag 4A-4N & 6A-6N, a basic label 300, the mobile device 18, verbally from a customer or by information provided in credit cards, debit cards and/or gift cards. The POS 20 determines in step 14.02 whether a customer has initiated a purchase session either via the mobile device 18 or by verbal communication. When no purchase session request is detected in step 14.02, the POS proceeds on to step 14.04 to determine whether to check again for purchase session requests at step 14.02 or in the alternative to proceed on to other computational processing in step 14.05

When the POS 20 determines in step 14.02 that a customer has initiated a purchase session either via the mobile device 18 or by verbal communication, the POS 20 proceeds on to the loop of steps 14.06 through 14.34 and requests and hopefully acquires related to a purchase request. The POS 20 initiates a purchase request message PUR.MSG.01 in step 14.06 and acquires or attempts to acquire additional information for inclusion in the purchase request message PUR.MSG.01 in steps 14.08 through 14.32.

The POS 20 determines in step 14.08 whether a customer identifier CUSTOMER.ID is associated with the requesting customer, and if a customer identifier CUSTOMER.ID is provided adds the customer identifier CUSTOMER.ID to the purchase request message PUR.MSG.01 in step 14.10.

The POS 20 determines in step 14.12 whether an alternate identifier ALT.ID is associated with the requesting customer, and if an alternate customer identifier ALT.ID is provided adds the alternate customer identifier ALT.ID to the purchase request message PUR.MSG.01 in step 14.14.

The POS 20 determines in step 14.16 whether a credit, debit or gift card account CREDIT.ID is associated with the requesting customer, and if a credit, debit or gift card account CREDIT.ID is provided adds the credit, debit or gift card account CREDIT.ID to the purchase request message PUR.MSG.01 in step 14.18.

The POS 20 determines in step 14.20 whether an item identifier ITEM.ID is associated with the item ITEM.01-ITEM.N selected for purchase, and if an item identifier ITEM.ID is provided adds the item identifier ITEM.ID to the purchase request message PUR.MSG.01 in step 14.22.

The POS 20 determines in step 14.24 whether an alternate item identifier ALT.ITEM.ID is associated with the item ITEM.01-ITEM.N selected for purchase, and if an alternate item identifier ALT.ITEM.ID is provided adds the alternate item identifier ALT.ITEM.ID to the purchase request message PUR.MSG.01 in step 14.26.

The POS 20 determines in step 14.28 whether a tag identifier TAG.ID is associated with the item ITEM.01-ITEM.N selected for purchase, and if an ASSOCIATED a tag identifier TAG.ID is provided adds the tag identifier TAG.ID to the purchase request message PUR.MSG.01 in step 14.30.

The POS 20 proceeds from either step 14.28 or step 14.30 to step 14.32 and adds purchase transaction data PURCHASE.DATA that documents the purchase and optionally a time date stamp TDS, a GPS data and/or a location identifier LOC.ID of the POS 20. The POS 20 then transmits the purchase message PUR.MSG.01 to the retail DB server 24 in step 14.34.

Referring now to FIG. 15, FIG. 15 is a block diagram of the exemplary purchase message PUR.MSG.01, or “first purchase message PUR.MSG.01”. The “first purchase message PUR.MSG.01” includes a purchase message identifier PUR.MSG.ID that uniquely identifies the first purchase message PUR.MSG.01 to the retail DB server 24; a network address of the retail DB server 24 entered in as a destination address of the first purchase message PUR.MSG.01; a unique network address POS.ADDR of the POS 20 as a sender network address; an optional additional server or system address CC.ADDR as an additional destination address of the first purchase message PUR.MSG.01; the customer identifier CUSTOMER.ID of step 14.10; the alternate customer identifier ALT.ID of step 14.12; the credit, debit or gift account data of step 14.18; the item identifier ITEM.ID of step 14.22, wherein the item identifier ITEM.ID may be a Universal Product Code or other proprietary or standard-conforming product, item, or type identifier or classification; the alternate item identifier ITEM.ID of step 14.24; the tag identifier TAG.ID detected in step 14.28 and added in step 14.30; purchase transaction data PURCHASE.DATA of step 14.32; the location identifier LOC.ID of the POS 20; a time date stamp TDS and/or a GPS datum GPS as generated or received by the POS 20.

FIG. 16 is a block diagram of an exemplary first customer record CUS.REC.01 as maintained by the a retail DB server, wherein each of a plurality of customer records CUS.REC.01-CUS.REC.N may associate each unique customer number CUSTOMER.DATA of a plurality of customer records with one or more tag identifiers TAG.ID.01-TAG.ID.N. The first customer record CUS.REC.01 may include a customer record identifier CUS.REC.ID.01 may further associate other data with the unique customer identifier CUSTOMER.ID of step 14.18, such as a customer name CUS.NAME; a customer network address CUS.ADDR; a customer postal address CUS.POST; the credit, debit or gift card account number CREDIT.ID of step 14.18; additional customer identifiers CUS.REC.ID.05, e.g., records associated with family members of the customer identified by the instant customer identifier CUSTOMER.ID; a plurality of purchase messages PUR.MSG.01, PUR.MSG.20 & PUR.MSG.N; a customer telephone number CUS.TEL, perhaps assigned to the mobile device 20; and additional customer information CUST.DATA.

It is understood that the customer records CUS.REC.01-CUS.REC.N may be applied by the retail DB 24 or other parties as authorized to associate a customer with items ITEM.01-ITEM.N purchased by the identified customer and/or with tag identifiers TAG.ID.01-TAG.ID.N that are also associated with individual items ITEM.01-ITEM.N.

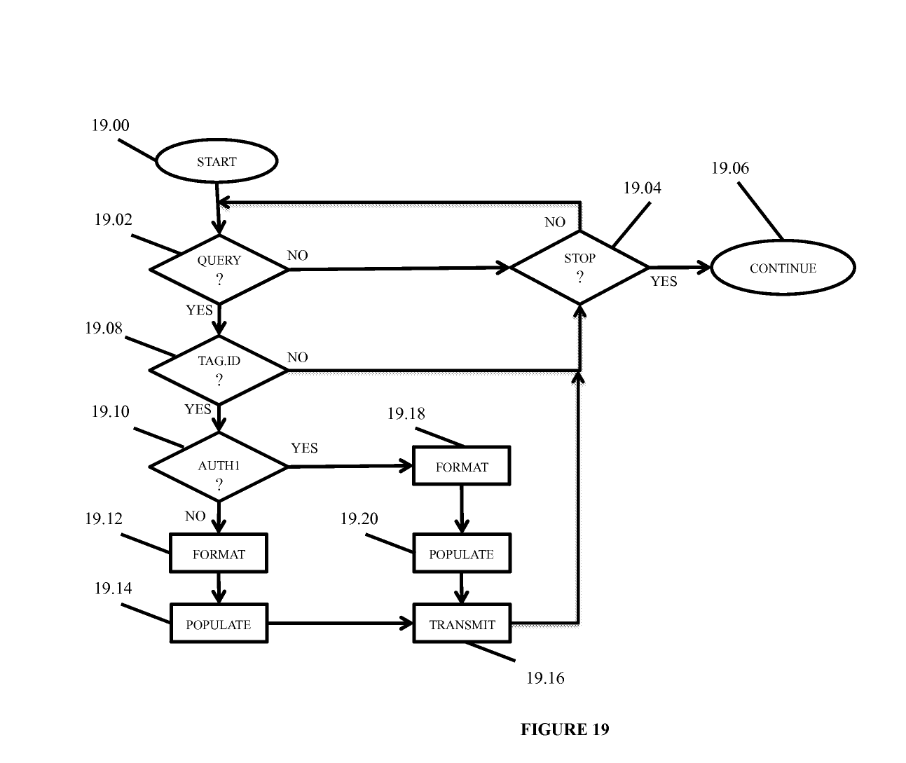

Referring now to the Figures generally and particularly to FIGS. 17 through 21, FIG. 19 is a software flow chart of a system or server 10, 16-20 & 26 having access to one or more tag history records HIST.REC.01-HIST.REC.N and responding to query messages Q.MSG.01-Q.MSG.N. The aspects of the invented method presented in FIG. 19 further provides that a party may request information from the servers 12 & 24 or other systems or servers 10, 16-20 & 26 by referencing a tag identifier TAG.ID or an item identifier ITEM.ID in an electronic query message Q.MSG. A recipient system 10, 16-20 & 26 of a query message Q.MSG may examine the Q.MSG to determine if an authorization code AUTH1 & AUTH2 is present or not, and determines what level of access to apply in responding to a query message Q.MSG in a reply message. The aspects of the invented method of FIG. 19 thereby allow various parties, both before and after a final retail purchase of an item ITEM.01-ITEM.N to access information about a particular item ITEM.01-ITEM.N of interest. Requesting parties may include consumers, purchasers, purchasing managers, operations managers and regulatory officers.

Referring now generally to the Figures and particularly to FIG. 17, FIG. 17 is a block diagram of a first query message Q.MSG.01 as generated and transmitted by the mobile device 18 as directed by a user thereof. The first query message Q.MSG.01 includes the tag DB server network address TD.ADDR 12.30 as a destination address; the mobile device network address MOB.ADDR. 18.30 as the sender address; the exemplary first tag identifier TAG.ID.01 and/or the associated first item identifier ITEM.ID.01; an optional time date stamp TDS as generated by the mobile device 18; and an optional GPS datum GPS as generated by the mobile device 18. It is understood that other query messages Q.MSG.02-Q.MSG.N may be sent from other systems 10-16 & 20-26 to other systems 10 & 16-26 of the network 2.

Referring now generally to the Figures and particularly to FIG. 18, FIG. 18 is a block diagram of a second query message Q.MSG.02 that as generated and transmitted by the retail DB server 24 either automatically or as directed by a user of the retail DB server 24. The second query message Q.MSG.02 includes the tag DB server network address TD.ADDR 12.30 as a destination address; the retail DB server network address RD.ADDR. 24.30 as the sender address; the exemplary first tag identifier TAG.ID.01 and/or the associated first item identifier ITEM.ID.01; an optional first authorization code AUTH1; and an optional second authorization code AUTH2.

Referring now generally to the Figures and particularly to FIG. 19, FIG. 19 is a software flowchart of a system or server 10, 16-20 & 26 having access to one or more tag history records HIST.REC.01-HIST.REC.N and responding to query messages Q.MSG.01-Q.MSG.N. For clarity of explanation, the process of FIG. 19 will be discussed as performed as instantiated by the tag DB system software TD.SYS.SW 12.24 by the tag DB server 12. It is understood that other systems and servers 10, 16 & 20-26 may perform the method of FIG. 19. In step 19.02 the tag DB server 12 determines whether a receipt of a query message Q.MSG.01-Q.MSG.N. When the tag DB server 12 does not detect a receipt of a query message Q.MSG.01-Q.MSG.N in step 19.02, the tag DB server 12 proceeds onto step 19.04 and determines whether to proceed on to step 19.06 and perform alternate computational operations or to return to an additional performance of step 19.02.

When the tag DB server 12 detects a receipt of a query message Q.MSG.01-Q.MSG.N in step 19.02, the tag DB server 12 proceeds onto step 19.08 and to determine whether the received query message Q.MSG.01-Q.MSG.N includes a tag identifier TAG.ID.01-TAG.ID.N or an item identifier ITEM.01-ITEM.N. Alternatively, when the tag DB server 12 determines in step 19.08 that the received query message Q.MSG.01-Q.MSG.N does not include a tag identifier TAG.ID.01-TAG.ID.N or an item identifier ITEM.01-ITEM.N, the tag DB server 12 proceeds on to step 19.04. Alternatively, when the tag DB server 12 determines in step 19.08 that the received query message Q.MSG.01-Q.MSG.N includes a tag identifier TAG.ID.01-TAG.ID.N or an item identifier ITEM.01-ITEM.N, the tag DB server 12 proceeds on to step 19.10.

The tag DB server 12 determines in step 19.10 whether the query message Q.MSG.01-Q.MSG.N received in step 19.02 includes an authorization code AUTH1 or AUTH2. When the tag DB server 12 determines in step 19.10 that the query message Q.MSG.01-Q.MSG.N received in step 19.02 does not include an authorization code AUTH1 or AUTH2, the tag DB server 12 proceeds from step 19.10 to step 19.12 and to format the exemplary first response message R.MSG.01. The tag DB server proceeds from step 19.12 to step 19.14 and to populate the exemplary first response message R.MSG.01 with the first source information SOURCE.DATA harvested from the exemplary first history record HIST.REC.01. The tag DB server 12 then proceeds on to step 19.16 and transmits the exemplary first response message R.MSG.01 to the original requestor, being the mobile device 18 in the case of the first exemplary query message Q.MSG.01. The tag DB server 12 proceeds from step 19.16 to step 19.04.

In the alternative, when the tag DB server 12 determines in step 19.10 that the query message Q.MSG.01-Q.MSG.N received in step 19.02 does include an authorization code AUTH1 or AUTH2, the tag DB server 12 proceeds from step 19.10 to step 19.18 and to format the exemplary second response message R.MSG.02. The tag DB server proceeds from step 19.18 to step 19.20 and to populate the exemplary second response message R.MSG.02 with the entire exemplary first history record HIST.REC.01. The tag DB server 12 then proceeds on to step 19.16 and transmits the exemplary second response message R.MSG.02 to the original requestor, the original requestor being the retail DB server 24 in the case of the second exemplary query message Q.MSG.02. As noted previously, the tag DB server 12 proceeds from step 19.16 to step 19.04.

It is understood that (a.) the origin system software OS SYS.SW 10.24 of the origin system 10, (b.) the retail system software RS SYS.SW 16.24 of the retail system 16, (c.) the POS system software POS SYS.SW 20.24 of the POS 20; (d.) the reader server system software RS SYS.SW 26.24 of the reader server 26 of the POS 20; and/or the retail DB server system software RD SYS.SW 24.24 of the retail DB server 24, may be adapted to instantiate some or all the aspects of the process of FIG. 19.

It is further understood that the one or more system software 10.24, 12.24, 16.24, 20.24, 24.24 & 26.24 may be adapted to recognize two or more levels of authorization that are each separately associated with a distinctive authorization code AUTH1 & AUTH2. For example, a provision of a first authorization code AUTH1 in a query message Q.MSG might be required to successfully direct the recipient system 10, 12, 16, 20, 24 & 26 to respond with a reply message R.MSG that contains entire registration records, whereas a provision of a second authorization code AUTH2 might successfully direct the recipient system 10, 12, 16, 20, 24 & 26 to respond with a reply message R.MSG that contains redacted or particular registration records.

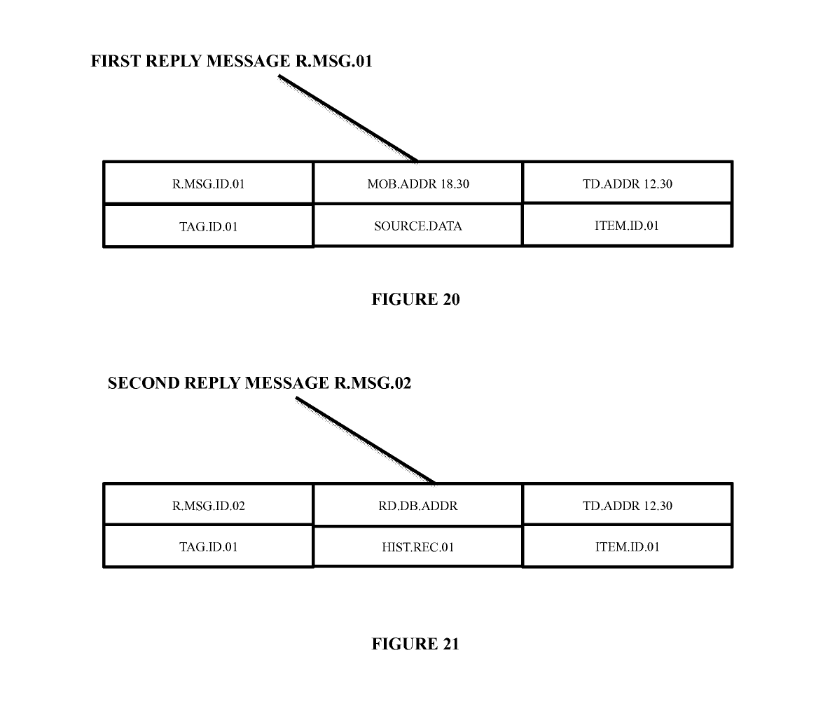

Referring now generally to the Figures and particularly to FIG. 20, FIG. 20 is a block diagram of a first reply message R.MSG.01 as generated and transmitted by the tag DB server 12 in steps 19.12 through 19.16 of the process of FIG. 19 as instantiated by the tag DB server 12. The first reply message R.MSG.01 includes (a.) a recipient address of the sender address of the first query message Q.MSG.01, i.e. the mobile device network address MOB.ADDR 18.30; (b.) the tag DB server network address 12.30; (c.) the first tag identifier TAG.ID.01; (d.) the first source information SOURCE.DATA of the first history record HIST.REC.01; and (e.) optionally the first item identifier ITEM.ID.01 that is associated in the first history record HIST.REC.01 with the exemplary first tag identifier TAG.ID.01.

It is understood that the source information SOURCE.DATA might include information about the original environs and conditions and original growers, providers and/or fabricators of the item ITEM.01-ITEM.N that is associated with the tag identifier TAG.ID.01-TAG.ID.N of a history record HIST.REC.01-HIST.REC.N. For example, the source information might provide textual data TXT.DATA, photographic or video data PHOT.DATA, and/or audio data AUDIO.DATA that relates to people, places and conditions related to the growth of the strawberries 312. It is understood that in this example of the strawberries 312, that the strawberries 312 in combination with the first container 310 comprise the exemplary first item ITEM.01, and that the first item identifier ITEM.ID.01 and the first tag identifier TAG.ID.01 are both written into the first history record HIST.REC.01 along with the instant source information SOURCE.DATA. The first item ITEM.01 and the first RFID tag are thereby associated with the first history record HIST.REC.01 and the instant source information SOURCE.DATA.

Referring now generally to the Figures and particularly to FIG. 21, FIG. 21 is a block diagram of a second reply message R.MSG.02 as generated and transmitted by the tag DB server 12 in steps 19.18, 19.20 and 19.16 of the process of FIG. 19 as instantiated by the tag DB server 12. The second reply message R.MSG.02 includes (a.) a recipient address of the sender address of the second query message Q.MSG.02, i.e. the retail DB server network address RD.ADDR 24.30; (b.) the tag DB server network address 12.30; (c.) the first tag identifier TAG.ID.01; (d.) the first history record HIST.REC.01; and (e.) optionally the first item identifier ITEM.ID.01 that is associated in the first history record HIST.REC.01 with the exemplary first tag identifier TAG.ID.01.

While the present invention may be susceptible to various modifications and alternative forms, specific embodiments have been shown by way of example in the drawings and will be described in detail herein. However, it should be understood that the techniques set forth in the present disclosure are not intended to be limited to the particular forms disclosed. Rather, the invention is to cover all modifications, equivalents and alternatives falling within the spirit and scope of the disclosure as defined by the following appended claims.

We claim:

1. A method for tracking movement of goods in transit, comprising:
a. providing an electronic device (“device”) comprising
i. a wireless bi-directional communications interface (“interface”);
ii. a logic unit bi-directionally communicatively coupled with the interface; and
iii. a memory bi-directionally communicatively coupled with the interface and the logic unit;
b. storing a unit identifier in the memory;
c. associating the unit identifier with a specific shipment unit of goods (“shipment unit”):
d. associating the unit identifier with a network address;
e. transporting the device and the shipment unit to a first location within a supply chain channel;
f. detecting the device at the first location; and
g. communicating the detection of the device in an electronic message addressed to the network address.

2. The method of claim 1, wherein the device further comprises a radio frequency identification device (“RFID”) and the RFID is bi-directionally communicatively coupled with the logic unit.

3. The method of claim 1 wherein the wherein the device further comprises an antenna coupled with a battery, the battery coupled with the logic unit and the memory, the battery adapted to provide electrical energy to the logic unit and the memory, and the antenna adapted to receive electromagnetic wave energy and to deliver electrical power derived from the received electromagnetic wave energy to the battery.

4. The method of claim 1, further comprising providing a shipment container for enclosing the shipment unit and coupling the device to the shipment container.

5. The method of claim 1, further comprising storing a source information related to a source of the unit shipment in the memory.

6. The method of claim 5, further comprising enabling access to the source information, whereby a party reads and publishes information related to the source of the unit shipment.

7. The method of claim 6, wherein the shipment unit comprises a food stuff.

8. The method of claim 6, wherein the shipment unit comprises an agricultural good.

9. The method of claim 6, wherein the source information is encrypted as stored within the memory.

10. The method of claim 6, wherein the source information is unencrypted as stored at a remote memory, the remote memory accessible by wireless communications means.

11. The method of claim 1, further comprising recording a date time stamp in association with the unit identifier at the first location.

12. The method of claim 1, further comprising recording a geolocational position data in association with the unit identifier at the first location, the geolocational position data specifying a geographic position of the first location.

13. The method of claim 1, wherein the device further comprises a geolocational positioning system receiver (“GPS receiver”) coupled with the logic unit, the GPS receiver receiving GPS data during transit of the device and the logic unit storing received GPS data in the memory, whereby, a plurality of locations of the device during transit are recorded in the memory.

14. The method of claim 13, further comprising storing at least time one date stamp with at least one storage of a received GPS data.

15. The method of claim 14, wherein the device further comprises a real time clock coupled with the logic unit, and the real time clock adapted to provide a time date stamp to the logic unit.

16. The method of claim 1, further comprising a capacitor coupled with the memory and the logic unit, and the capacitor adapter to provide energy to the memory and the logic unit.

17. The method of claim 1, further comprising a solar energy converter coupled a battery, the solar energy converter adapted to provide electrical energy to the battery, and the battery coupled with the logic unit and the memory and adapted to provide electrical power to the logic unit and the memory.

18. The method of claim 1, further comprising adapting the logic unit to broadcast data in accordance with at least one programmed algorithm.

19. The method of claim 1, further comprising enabling a party access to additional information related to the unit shipment by means of the internet.

20. A system comprising:
a. an electronic device (“device”) comprising
i. a wireless bi-directional communications interface (“interface”);
ii. a logic unit bi-directionally communicatively coupled with the interface; and
iii. a memory bi-directionally communicatively coupled with the interface and the logic unit;
b. a unit identifier stored in the memory, the unit identifier related to a specific shipment unit of goods; and
c. means for a purchaser to access information related to the unit identifier.

21. A system comprising:
a. an electronic device (“device”) comprising
i. a wireless bi-directional communications interface (“interface”);
ii. a logic unit bi-directionally communicatively coupled with the interface; and
iii. a memory bi-directionally communicatively coupled with the interface and the logic unit;
b. a unit identifier stored in the memory, the unit identifier related to a specific shipment unit of goods;
c. a source information stored in the memory, the source information comprising information relevant to consumer interest in the shipment unit of goods; and
d. means for a consumer to access the source information.
